(19) United States
(12) Patent Application Publication
(10) Pub. No.: US 2023/0277415 A1
(43) Pub. Date: Sep. 7, 2023

(54) POLYMER VIALS HAVING STANDARD EXTERNAL DIMENSIONS AND REDUCED INTERNAL VOLUME

(71) Applicant: SIO2 MEDICAL PRODUCTS, INC., Auburn, AL (US)

(72) Inventors: Michael Bucholtz, Auburn, AL (US); Matthew Nagy, Auburn, AL (US)

(21) Appl. No.: 18/316,308

(22) Filed: May 12, 2023

Related U.S. Application Data
(63) Continuation of application No. PCT/US2021/072558, filed on Nov. 22, 2021.
(60) Provisional application No. 63/116,557, filed on Nov. 20, 2020.

(51) Int. Cl. A61J 1/05; A61J 1/14; B65D 77/04; B65D 65/42; B29C 45/26

(52) U.S. Cl. CPC A61J 1/05; A61J 1/1412; A61J 1/1468; B65D 77/0493; B65D 65/42; B29C 45/2612; B29L 2031/712

(57) ABSTRACT

Disclosed is a vial having an external base and an external sidewall extending up from the external base. The external sidewall narrows at an upper section of the vial to form a neck. The neck leads to a rim surrounding an opening providing access to a product compartment. The external base, the external sidewall, the neck and optionally the rim together define an outer profile of the vial. The outer profile is preferably round and symmetrical about a central axis. The vial further includes an internal sidewall that is spaced radially inward relative to the external sidewall such that a void exists between the internal sidewall and the external sidewall. The internal sidewall preferably extends from an internal portion of the neck, downward to an internal base. The internal sidewall and internal base form an enclosure that defines the product compartment.

### CROSS-REFERENCE TO RELATED APPLICATIONS

This application claims priority to U.S. Provisional Patent Application No. 63/116,557, entitled “POLYMER VIALS HAVING STANDARD EXTERNAL DIMENSIONS AND REDUCED INTERNAL VOLUME,” filed on Nov. 20, 2020, the contents of which are incorporated herein by reference in their entirety.

### BACKGROUND OF THE INVENTION

### 1. Field of Invention

The disclosed concept relates to plastic containers or vessels and methods of making the same. More particularly, the disclosed concept relates to vials having ISO standard external dimensions while having a reduced internal volume. With ISO standard external dimensions, the vial may run through standard equipment and process seamlessly (i.e., the vial serves as a drop in for the standard vial).

### 2. Description of Related Art

An important consideration for pharmaceutical packages or vessels, e.g., parenteral vials, is that the contents have a substantial shelf life.

For decades, most parenteral therapeutics have been delivered to end users in Type I medical grade borosilicate glass vessels such as vials. The relatively strong, impermeable and inert surface of borosilicate glass has performed adequately for most drug products. However, the recent advent of costly, complex and sensitive biologics has exposed the physical and chemical shortcomings of glass pharmaceutical packages, including possible contamination from metals, flaking, delamination, and breakage, among other problems. Moreover, glass contains several components which can leach out during storage and cause damage to the stored material.

In more detail, borosilicate pharmaceutical packages or other vessels, e.g., vials, exhibit a number of drawbacks. Glass is manufactured from sand containing a heterogeneous mixture of many elements (silicon, oxygen, boron, aluminum, sodium, calcium) with trace levels of other alkali and earth metals. Type 1 borosilicate glass consists of approximately 76% SiO₂, 10.5% B₂O₃, 5% Al₂O₃, 7% Na₂O and 1.5% CaO and often contains trace metals such as iron, magnesium, zinc, copper and others. The heterogeneous nature of borosilicate glass creates a non-uniform surface chemistry at the molecular level.

Glass forming processes used to create glass vessels expose some portions of the vessels to temperatures as great as 1,200° C. Under such high temperatures, alkali ions migrate to the local surface and form oxides. The presence of ions extracted from borosilicate glass devices may be involved in degradation, aggregation and denaturation of some biologics. Many proteins and other biologics must be lyophilized (freeze dried), because they are not sufficiently stable in solution in glass vials. Moreover, for drugs that are cryogenically frozen, glass vials have a propensity to shatter at cryogenic temperatures (e.g., −196° C.).

Plastic provides one alternative to glass for parental packaging. Although plastic is superior to glass with respect to breakage, dimensional tolerances and surface uniformity, its use in primary pharmaceutical packaging remains limited due to certain shortcomings, including gas permeability and leachables/extractables. Regarding gas permeability, plastic allows small molecule gases to permeate through it. This includes, among other things, permeability to oxygen and water vapor. This can be detrimental to the shelf life of some drugs, such as lyophilized drugs. Regarding leachables and extractables, plastic vessels contain organic compounds that can extract out into the stored drug product. These compounds can contaminate the drug and/or negatively impact the drug's stability.

The assignee of the present application has developed certain coating technologies and processes that may provide certain benefits of glass on an otherwise plastic vessel. Such coating technologies allow one to leverage beneficial aspects of plastic without countervailing disadvantages. These coating technologies are described below in the specification in conjunction with their potential use with optional aspects of the disclosed concept.

Cell and gene therapies have become an ever-increasing market segment. These custom treatments are very expensive and, as such, it is important to avoid overfilling so as not to waste any volume of the drug in a package. In addition, the batch sizes for early-stage drug development are small and minimizing the dead volume in vials used in early clinical trials is increasingly important. Existing vials are typically overfilled in order to deliver the needed amounts. This procedure of using existing vials leaves behind an amount of material that is simply wasted. Accordingly, there is an industry need for an improved vessel or container, e.g., vial, to eliminate the waste and cost from overfilling, especially for high value drugs and drugs in early-stage development.

### SUMMARY OF THE INVENTION

Accordingly, in one optional embodiment, a vial is provided. The vial includes an external base and an external sidewall extending up from the external base. The external sidewall narrows at an upper section of the vial to form a neck. The neck leads to a rim surrounding an opening providing access to a product compartment. The external base, the external sidewall, the neck and optionally the rim together define an outer profile of the vial. The outer profile is preferably round and symmetrical about a central axis. The vial further includes an internal sidewall that is spaced radially inward relative to the external sidewall such that a void exists between the internal sidewall and the external sidewall. The internal sidewall preferably extends from an internal portion of the neck, downward to an internal base. The internal sidewall and internal base form an enclosure that defines the product compartment.

Optionally, in any embodiment, the external base, the external sidewall, the neck and the rim together define the outer profile.

Optionally, in any embodiment, the vial is round and symmetrical about the central axis.

Optionally, in any embodiment, the internal sidewall extends from the internal portion of the neck.

Optionally, in any embodiment, the vial is made from a thermoplastic material.

Optionally, in any embodiment, the vial is formed by injection molding. The injection mold would optionally include side action to form the neck finish region.

Optionally in any embodiment, the outer profile of the vial has dimensions that comply with ISO 8362-7:2006.

Optionally, in any embodiment, the vial is provided in an ISO standard 2R format, optionally in an ISO standard 4R format, optionally in an ISO standard 5R format, optionally in an ISO standard 6R format, optionally in an ISO standard 10R format, optionally in an ISO standard 15R format, optionally in an ISO standard 20R format, optionally in an ISO standard 30R format, optionally in an ISO standard 50R format, optionally in an ISO standard 100R format.

Optionally, in any embodiment, the product compartment is in fluid communication with a stopper cavity located directly above the product compartment, the stopper cavity being defined by a portion of the vial located inward of the neck and optionally the rim, the stopper cavity being configured and sized to receive a portion of a stopper to seal the vial.

Optionally, in any embodiment, the vial is made from an olefin polymer or copolymer, optionally cyclic olefin polymer, cyclic olefin copolymer, polyethylene and/or polypropylene.

Optionally, in any embodiment, the vial is made from polycarbonate.

Optionally, in any embodiment, the product compartment is conical, frustoconical or substantially conical in profile.

Optionally, in any embodiment, the product compartment is configured to store precisely 0.50 mL of product and optionally has an outer profile with standard dimensions of an ISO standard 2 mL vial.

Optionally, in any embodiment, the vial includes an external vial surface that includes an outer surface of the external sidewall, an outer surface of the neck and an outer surface of the rim. Optionally, in any embodiment, the vial includes an internal surface that includes an inside of the product compartment and any other surface in fluid communication therewith. Optionally, in any embodiment, the vial includes an external product compartment surface that includes an outer surface of the product compartment. Optionally, at least a portion of at least one of the external vial surfaces, the internal surface and the external product compartment surface has at least one PECVD coating or layer disposed thereon. Optionally, this would include a PEC VD water barrier coating or layer deposited onto at least a portion of at least one of the external vial surface, the internal surface and the external product compartment surface. The PECVD water barrier coating or layer has a water contact angle of from 80 to 180 degrees, optionally from larger than 80 degrees to less than 180 degrees, optionally from 90 degrees to 160 degrees, optionally from 100 degrees to 150 degrees, optionally from 110 degrees to 150 degrees. Optionally, the PECVD water barrier coating or layer is applied through a process that includes: in a PECVD apparatus, supplying a water barrier coating or layer precursor to the vial and creating a plasma using the same, the water barrier coating or layer precursor including at least one of a saturated or unsaturated, linear or cyclic aliphatic fluorocarbon precursor having from 1 to 10, optionally 1 to 6, optionally 2 to 6 carbon atoms and from 4 to 20 fluorine atoms per molecule, optionally hexafluropropylene (C₃F₆), octafluorocyclobutane (C₄F₈), tetrafluoroethylene (C₂F₄), hexafluoroethane (C₂F₆), hexafluoropropylene (C₃F₆), octafluorocyclobutane (C₄F₈), perfluorohexane (C₆F₁₄) or perfluoro-2-methyl-2-pentene (C₆F₁₂), the water barrier coating or layer precursor further comprising a saturated or unsaturated hydrocarbon having from 1 to 6 carbon atoms, for example lower alkanes having from 1 to 4 carbon atoms, alkenes or alkynes having from 2 to 4 carbon atoms, for example acetylene (C₂H₂) or methane (CH₄), optionally acetylene (C₂H₂), a saturated or unsaturated hydrofluorocarbon having from 1 to 6 carbon atoms, or any combination thereof.

Optionally, in any embodiment, the vial has a PECVD tri-layer coating set deposited onto the internal surface.

Optionally, in any embodiment, a PECVD water barrier coating or layer is deposited onto the internal surface and a PECVD tri-layer coating set is deposited atop the PECVD water barrier coating or layer.

Optionally, in any embodiment, a PECVD tri-layer coating set is deposited onto the internal surface and the PECVD water barrier coating or layer is deposited atop the PECVD tri-layer coating set.

Optionally, in any embodiment, the vial has a cap or stopper to fully or partially close the opening.

Optionally, in any embodiment, the vial has optical clarity for visual particle inspection of drug product stored in the product compartment.

Optionally, in any embodiment, the vial has dimensional consistency.

Optionally, in any embodiment, the vial maintains container closure integrity with ISO standard butyl rubber closures.

Optionally, in any embodiment, the vial is able to withstand terminal steam sterilization and maintain functionality during and after the terminal steam sterilization, the terminal steam sterilization optionally being done at 121° C. for up to 30 minutes.

Optionally, in any embodiment, the vial can withstand cryogenic storage and maintain functionality during and after the cryogenic storage, the cryogenic storage optionally being at temperatures of from −70° C. to −196° C.

Optionally, in any embodiment, the vial can withstand thermal cycling at temperatures of from −70° C. to 25° C. or −196° C. to 25° C. and maintain functionality during and after the thermal cycling. Optionally, the vial, when containing liquid drug contents, is subjected to cryogenic freezing.

Optionally, in any embodiment, the vial can withstand ethylene oxide sterilization and maintain functionality during and after the ethylene oxide sterilization.

Optionally, in any embodiment, the vial can withstand sterilization by irradiation (optionally up to 50 kGy) and maintain functionality during and after the sterilization by irradiation.

Optionally, in any embodiment, the vial is configured to be run through industry standard fill/finish equipment.

Optionally, in any embodiment, the vial is configured to fit ISO standard secondary packaging, for example ready to use format 10×10 nested format for the 2R vial.

Optionally, in any embodiment, the vial includes drug contents stored in the product compartment.

Optionally, in any embodiment, the drug contents in the vial are in liquid, frozen or lyophilized forms.

Optionally, in any embodiment, the drug contents in the vial comprise biologic drugs, gene therapy or viral vectors.

Optionally, in any embodiment of a vial according to the disclosed concept, the vial is made from an olefin polymer or copolymer, optionally cyclic olefin polymer or cyclic olefin copolymer. Optionally, in any embodiment of a vial according to the disclosed concept, the vial is polypropylene, polyethylene or any suitable material for packaging injectable drugs.

Optionally, in any embodiment of a vial according to the disclosed concept, a lyophilized product is stored within the interior, the lyophilized product configured to be reconstituted into a liquid product. Optionally, the lyophilized product is a biologic drug, a gene therapy or viral vector.

Optionally, in any embodiment, the vial of the disclosed concept may more generally be referred to as container or vessel.

Optionally, in any embodiment of a vial according to the disclosed concept, the internal sidewall extends from the internal portion of the neck, downward to the internal base, the internal sidewall having an inner diameter no greater than the inner diameter of the neck.

Optionally, in any embodiment, the vial of the disclosed concept includes a plurality of ribs running axially between the internal sidewall and external sidewall so as to occupy a portion of the void. The ribs bridge the internal sidewall with the external sidewall so as to reinforce the external sidewall, e.g., against inward deflection and/or axial compression.

Optionally, in any embodiment, the vial of the disclosed concept includes a bottom cap assembled to an underside of the vial. Optionally, the bottom cap provides a seating surface configured to stabilize the vial when standing upon a resting surface. Optionally, the bottom cap is assembled to an inner surface of the external sidewall at a location adjacent to the external base, optionally by interference fit, welding, heat staking, overmolding or multi-shot injection molding. Optionally, the bottom cap has a thru-hole into which the internal base protrudes and with which the internal base engages, optionally in an interference fit. Optionally, the bottom cap includes a plurality of openings configured to allow sterilization gas to migrate into the void during a sterilization procedure.

In an optional aspect, a method of making the vial of any embodiment herein is disclosed, the method including injection molding the vial. Optionally, this method includes providing a mold cavity in the shape of the outer profile of the vial and disposing into the mold cavity a core pin to form the shape of the inside of the product compartment. The core pin preferably has a draft angle so as to make the internal sidewall substantially conical or frustoconical in shape along a substantial length thereof. Optionally, the core pin has a slight annular bump used to form a small annular undercut in the internal surface of the vial internal to the neck or rim, optionally wherein the undercut has a radius of from 0.001 to 0.01 inches. Optionally, the internal sidewall of the vial extends from the internal portion of the neck, downward to the internal base, the internal sidewall having an inner diameter no greater than the inner diameter of the neck.

### BRIEF DESCRIPTION OF SEVERAL VIEWS OF THE DRAWINGS

The background of the invention and the invention itself will be described in conjunction with the following drawings in which like reference numerals designate like elements and wherein:

FIG. 1 is an isometric view of an optional vial according to an aspect of the disclosed concept.

FIG. 2 is a front elevation view of the vial of FIG. 1.

FIG. 3 is section view of the vial of FIG. 1.

FIG. 3A is an enlarged section view of a portion of the neck and rim of the vial of FIG. 1.

FIG. 4 is a second isometric view of the vial of FIG. 1.

FIG. 5A is an exploded section view of a variation of the vial of FIG. 1.

FIG. 5B is a section view of the vial of FIG. 5A in assembled form.

FIG. 5C is an isometric view of the vial of FIG. 5B.

FIG. 6 shows a schematic diagram of a PECVD apparatus that may be used to apply PECVD layers, e.g., surface barrier coatings or layers and/or protective or passivation coatings or layers, in accordance with at least one optional aspect of the disclosed concept.

### DETAILED DESCRIPTION OF PREFERRED EMBODIMENTS OF THE INVENTION

The disclosed concept will now be described more fully with reference to the accompanying drawings, in which several embodiments are shown. This invention may, however, be embodied in many different forms and should not be construed as limited to the embodiments set forth here. Rather, these embodiments are examples of the invention, which has the full scope indicated by the language of the claims. Like numbers refer to like elements throughout. Unless indicated otherwise, the features characterizing the embodiments and aspects described in the following may be combined with each other, and the resulting combinations are also embodiments of the present invention.

### Definitions

As used in this disclosure, an “organosilicon precursor” is a compound having at least one of the linkages:

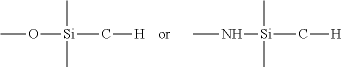

which is a tetravalent silicon atom connected to an oxygen or nitrogen atom and an organic carbon atom (an organic carbon atom being a carbon atom bonded to at least one hydrogen atom). A volatile organosilicon precursor, defined as such a precursor that can be supplied as a vapor in a plasma enhanced chemical vapor deposition (PECVD) apparatus, is an optional organosilicon precursor. Optionally, the organosilicon precursor is selected from the group consisting of a linear siloxane, a monocyclic siloxane, a polycyclic siloxane, a polysilsesquioxane, an alkyl trimethoxysilane, a linear silazane, a monocyclic silazane, a polycyclic silazane, a polysilsesquiazane, and a combination of any two or more of these precursors. Preferably, the organosilicon precursor is octamethylcyclotetrasiloxane (OMCTS). Values of w, x, y, and z are applicable to the empirical composition Si_{w}OₓC_{y}H_{z} throughout this specification. The values of w, x, y, and z used throughout this specification should be understood as ratios or an empirical formula (for example for a coating or layer), rather than as a limit on the number or type of atoms in a molecule. For example, octamethylcyclotetrasiloxane, which has the molecular composition Si₄O₄C₈H₂₄, can be described by the following empirical formula, arrived at by dividing each of w, x, y, and z in the molecular formula by 4, the largest common factor: Si₁O₁C₂H₆. The values of w, x, y, and z are also not limited to integers. For example, (acyclic) octamethyltrisiloxane, molecular composition Si₃O₂C₈H₂₄, is reducible to Si₁O_{0.67}C_{2.67}H₈. Also, although SiOₓC_{y}H_{z} is described as equivalent to SiOₓC_{y}, it is not necessary to show the presence of hydrogen in any proportion to show the presence of SiOₓC_{y}.

“PECVD” refers to plasma enhanced chemical vapor deposition.

A “vial,” as that term is used herein, refers generally to a rigid or semi-rigid container or vessel having a comparatively narrow neck and/or mouth. A vial is typically symmetrical about its central axis, is optionally round and is preferably clear in appearance so that its contents are clearly visible.

The terms “up,” “upper” or “upward” and “down” or “downward,” with respect to positioning or direction of aspects of a vial (aside from levels of coating layers), assume a standard orientation in which the vial is standing upright, i.e., with the base of the vial standing upon a resting surface (e.g., table).

### Optional Vial Configurations

Optionally, in any embodiment, the disclosed concept is a container, vessel or vial having external dimensions (height and diameter) that meet ISO standards, particularly the standards described in ISO 8362-7:2006. A vial according to an optional aspect of the disclosed concept, for example, may be provided in an ISO standard 2R format, optionally in an ISO standard 4R format, optionally in an ISO standard 5R format, optionally in an ISO standard 6R format, optionally in an ISO standard 10R format, optionally in an ISO standard 15R format, optionally in an ISO standard 20R format, optionally in an ISO standard 30R format, optionally in an ISO standard 50R format, optionally in an ISO standard 100R format.

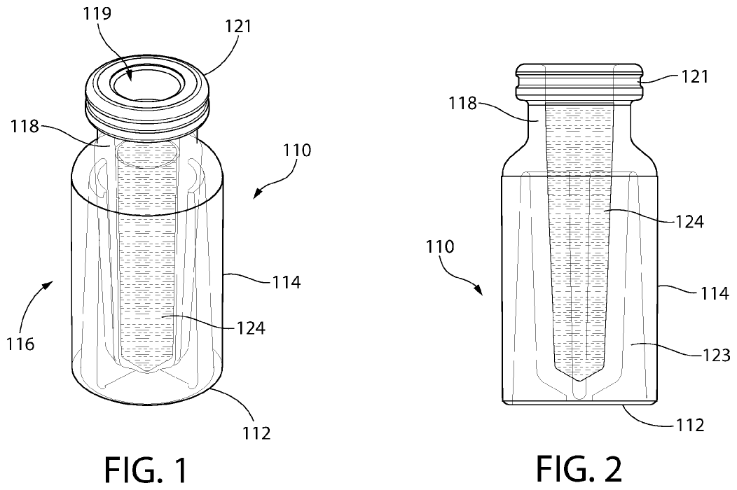

FIGS. 1 to 4 illustrate an optional embodiment of a vial 110 according to an aspect of the disclosed concept. The vial 110 is preferably clear and glass-like in appearance to allow for visual inspection of vial contents. The vial 110 is preferably made using an injection molding process, as explained further below. The vial 110 includes an external base 112 and an external sidewall 114 extending up from the external base 112. The external sidewall 114 narrows at an upper section of the vial 110 to form a neck 118, optionally leading to an annular rim 121 protruding radially outward and surrounding an opening 119, from which stored product may be accessed or dispensed. The external base 112, external sidewall 114 and neck 118 (and optionally rim 121) together define an outer profile 116 of the vial 110 that conforms, in configuration and dimensions, to the relevant ISO standards, as described herein. The outer profile 116 of the vial 110 is preferably round and symmetrical about a central axis, having the appearance and outer configuration of a bottle (i.e., with a comparatively wider body than neck). The vial 110 shown meets ISO 2R standard, but it should be understood that the vial 110 could be provided in alternative formats (e.g., 5R, 10R, etc.), as described herein.

Uniquely, the vial 110 includes an internal sidewall 120 that is spaced radially inward relative to the external sidewall 114. In other words, the internal sidewall 120 is a separate structure from the external sidewall 114 and does not constitute, for example, merely an inner surface of the external sidewall 114. As such, there is preferably a cavity, i.e., a void 123 between at least some of the internal sidewall 120 and external sidewall 114. Optionally, a plurality of ribs 125, e.g., running axially between the internal sidewall 120 and external sidewall 114 occupy a portion of the void 123, bridging the internal sidewall 120 with the external sidewall 114. The ribs 125 provide structural integrity to the vial 110 by reinforcing the external sidewall 114, e.g., against both radial and axial stress.

The internal sidewall 120 preferably extends from an internal portion of the neck 118 (sharing the same inner diameter as the neck 118 or at least not a greater inner diameter than the neck 118), downward to an internal base 122. The internal sidewall 120 and internal base 122 together define a product compartment 124 configured to store product. The product compartment 124 is preferably conical, frustoconical, or substantially conical in profile, but may be other shapes, e.g., having a rounded bottom, for example. Optionally, the internal sidewall 120 tapers inwardly continuously from the neck 118 until the internal base 122 or at least nearly to the internal base (e.g., as shown) and is symmetrical about the central axis of the vial 110. Optionally, a liquid drug product 127 is stored within the product compartment 124. The product compartment 124 is optionally in fluid communication with a headspace or stopper cavity 126 located directly above where the product 127 is stored in the product compartment 124 within the vial 110. The stopper cavity 126 is optionally configured and sized to receive a portion of a stopper, e.g., an elastomeric plug, to seal the vial 110.

In the embodiment shown, the product compartment 124 is configured to store precisely 0.50 mL of product. In other words, the vial 110 as shown appears to be a larger vial than the actual internal capacity is, e.g., having outer configuration and dimensions of an ISO standard 2 mL vial with a fill volume of only 0.50 mL. This solution thus eliminates the waste and cost of overfilling, which can occur with a standard vial that does not have the reduced internal volume of the disclosed concept. The size and shape of the product compartment 124 is configured to reduce dead volume, i.e., to maximize the usable portion of the drug stored in the vial 110. Optionally, alternative internal volumes (other than 0.50 mL) may be provided.

Optionally, but preferably, the vial 110 is made in an injection molding process. The injection mold would include side action to form the neck finish region. The vial 110 has an outer profile 116 that meets the ISO dimensions for outside diameter. The diameter of the internal sidewall 120, at its largest point, is generally the diameter of the neck finish internal diameter. The Applicant has found that injection molding the vial 110 is advantageous over other methods (e.g., blow molding or injection stretch blow molding) that are typical for making plastic vials that are in the shape of bottles (i.e., with narrowed necks). Injection molding ensures uniformity and consistency of vial wall thickness. Dimensional control and tolerances of the resulting part can improve the thermal efficiency of the vial. Minimizing side wall thickness variation facilitates more consistent heat transfer during a freeze drying (lyophilization) cycle. Consistent side wall thickness measured radially (i.e., 360° around a central axis of the vial) appears to be more important than consistency of wall thickness measured axially (i.e., wall thickness at the top of the vial versus that near the bottom). In addition to advantages relating to thermal efficiency, sidewall thickness consistency through injection molding provides improved optical properties, e.g., for visual inspection of the drug product contained in the vial. Injection molding also helps to reduce any adverse effect on polymer molecule density, to reduce cracking of the vial at cryogenic temperatures, e.g., down to −196° C.

The ability to injection mold the vial 110 is owed to its unique configuration, characterized by ISO standard outer profile and dimensions and a product compartment 124 having a maximum inner diameter no greater than the maximum inner diameter of the neck 118 and rim 121. This configuration allows use of a core pin in the injection mold to form the shape of the inside of the product compartment 124, without blow molding. Preferably, the core pin has at least a slight draft angle so as to make the internal sidewall 120 substantially conical or frustoconical in shape along a substantial length thereof. The end result of the injection molding process is a vial 110 having ISO standard outer dimensions and configuration and a product compartment 124 having a fill volume that is less, optionally substantially less, than a comparable ISO standard vial with standard fill volume. For example, in an embodiment, a vial 110 according to the disclosed concept having outer dimensions indicative of an ISO standard 2 mL vial may have a fill volume of 0.5 mL. This enables storage of precise amounts of drug product for administration without the need to overfill and potentially waste expensive drugs.

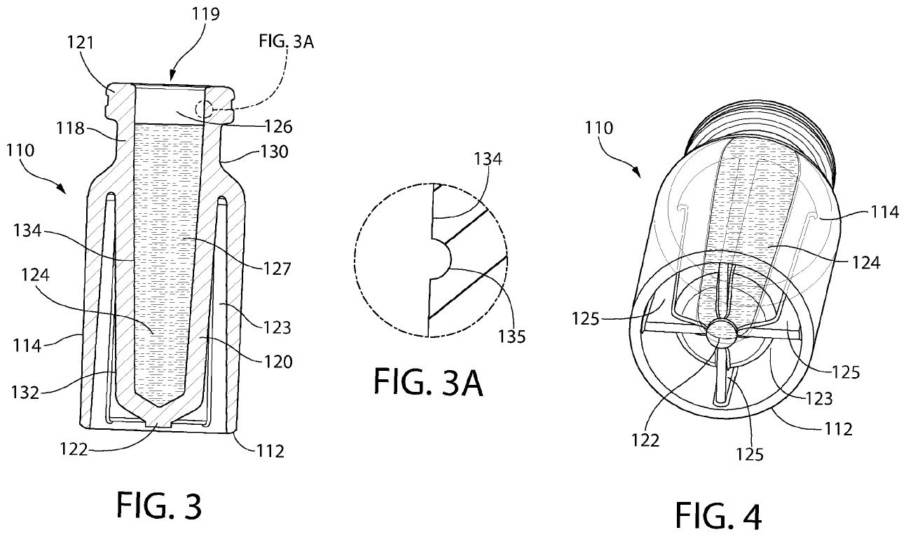

Referring to FIG. 3A, the vial 110 optionally includes a small annular undercut 135 in an internal surface 134 of the vial 110, in the vicinity of the neck 118 and rim 121. Optionally, the undercut 135 has a radius of from 0.001 to 0.01 inches, optionally about 0.003 inches. This small undercut 135 assists with pulling the vial 110 out of the mold after the molding process is complete. A small annular bump on the core pin in the mold forms the undercut during injection molding. The bump creates a lock on the inner diameter so that when the mold opens, the parts consistently pull to the ejection side of the mold every time. In addition, the undercut 135 optionally helps to improve seal integrity when the vial 110 is sealed shut, e.g., with an elastomeric stopper. The stopper would plug up the opening 119 in order to seal in the contents. In very low temperatures, e.g., such as those used for cryogenic freezing, rubber tends to contract. As the elastomeric stopper is configured to apply radial pressure to the internal surface 134 owing to its dimensions (an outer diameter, which when the stopper is in an uncompressed state, is larger than the inner diameter of the neck 118) and elasticity, contraction of the elastomer under cryogenic temperatures could adversely impact the seal that the plug was intended to create. Advantageously, the elastomeric plug, prior to freezing, would expand into and fill the undercut 135. When freezing temperatures cause the elastomeric material of the plug to contract, the portion of the plug that fills the undercut 135 would tend to remain stuck within the undercut 135, thus improving seal integrity.

As described in greater detail below, the vial 110 may include on it various PECVD coatings or layers to provide barrier and/or other desirable properties. Optionally, one or more PECVD coatings or layers may be deposited onto an external surface 130 of the vial 110. The external surface 130 comprises the outer surface of the external sidewall 114, neck 118 and/or rim 121. Optionally, one or more PECVD coatings or layers may be deposited onto an external surface 132 of the product compartment 124. Optionally, one or more PECVD coatings or layers may be deposited onto the internal surface 134 of the vial 110, which includes the inside of the product compartment 124 and any other internal surface that is in fluid communication with the product compartment 124 (e.g., the inner surface of the neck 118 and rim 121). Generically, it may be stated that one or more PECVD coatings or layers, as described herein, are optionally deposited on one or more surfaces 130, 132, 134 of the vial 110.

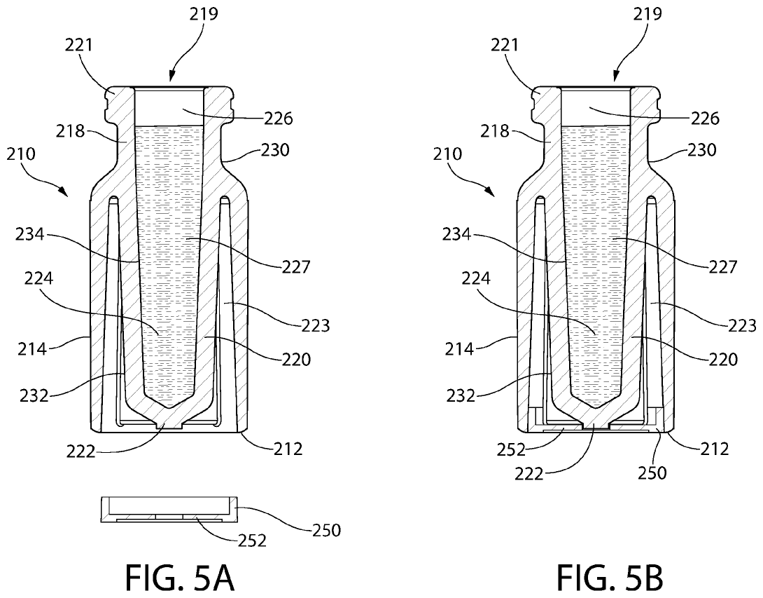

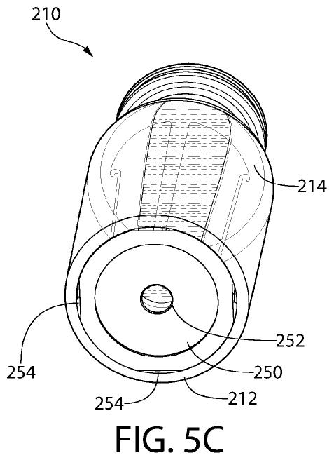

Referring to FIGS. 5A-5C, there is shown a variation of the vial 110 of FIGS. 1-4. The vial 210 of FIGS. 5A-5C may be substantially similar or identical in every respect to the other vial 110, except that that the alternative vial 210 further comprises a bottom cap 250 that is assembled to the underside of the vial 210. The two vials 110, 210 are described herein as variations of one another rather than as separate and distinct embodiments, given their substantial similarities, aside from the presence or absence of the bottom cap 250. Similar or identical structure as between the vial 110 of FIGS. 1-4 and the vial 210 of FIGS. 5A-5C is distinguished in FIGS. 5A-5C by a reference number with a magnitude one hundred (100) greater than that of FIGS. 1-4. Description of certain similarities between the embodiment of FIGS. 1-4 and the embodiment of FIGS. 5A-5C may be omitted herein for convenience and brevity only.

The bottom cap 250 of the vial 210 provides additional surface area to the base of the vial 210 to stabilize it when standing upon a resting surface. The bottom cap 250 may optionally be assembled by interference fit, welding or heat staking with the inner surface of the external sidewall 214 at a location adjacent to the external base 212. Alternatively, the bottom cap 250 may be overmolded with the vial 210 or is fabricated with the vial 210 in a multi-shot molding process. The bottom cap 250 optionally includes a thru-hole 252 into which the internal base 222 protrudes and with which the internal base 222 engages. In addition, the bottom cap 250 optionally includes openings, e.g., slots 254 around the periphery thereof, to allow for sterilization gas to migrate into the void during a sterilization procedure (e.g., ethylene oxide gas sterilization).

### Optional Vial Materials

Optionally, vessels, e.g., vials according to any embodiment of the invention may be made from one or more (e.g., as a composite or blend) injection moldable thermoplastic materials including, but not limited to: an olefin polymer; polypropylene (PP); polyethylene (PE); cyclic olefin copolymer (COC); cyclic olefin polymer (COP); polymethylpentene; polyester; polyethylene terephthalate; polyethylene naphthalate; polybutyleneterephthalate (PBT); PVdC (polyvinylidene chloride); polyvinyl chloride (PVC); polycarbonate; polymethylmethacrylate; polylactic acid; polystyrene; hydrogenated polystyrene; poly(cyclohexylethylene) (PCHE); nylon; polyurethane polyacrylonitrile; polyacrylonitrile (PAN); an ionomeric resin; and Surlyn® ionomeric resin. For applications in which clear and glass-like polymers are desired, a cyclic olefin polymer (COP), cyclic olefin copolymer (COC) or polycarbonate may be preferred. Such materials may be manufactured, e.g., by injection molding, to very tight and precise tolerances (generally much tighter than achievable with glass).

Preferably, the material is an amorphous polymer, such as a cyclic olefin polymer (COP), instead of a crystalline material. Amorphous polymers can be defined as polymers that do not exhibit any crystalline structures in X-ray or electron scattering experiments. They form a broad group of materials, including glassy, brittle and ductile polymers. Amorphous materials have no patterned order between the molecules. Amorphous materials include atactic polymers since the molecular structure does not generally result in crystallization. Examples of these types of plastics are polystyrene. PVC and atactic polypropylene. The presence of polar groups, such as a carbonyl group CO in vinyl type polymers, also restricts crystallization. Polyvinyl acetate, all polyacrylates and polymethylacrylates are examples of carbonyl groups being present and the resulting groups being amorphous. Polyacrylonitrile is an exception to this. Even amorphous materials can have a degree of crystallinity with the formation of crystallites throughout their structure. The degree of crystallinity is an inherent characteristic of each polymer but may also be affected or controlled by processes such as polymerisation and molding.

Crystalline materials exhibit areas of highly organized and tightly packed molecules. These areas of crystallinity are called spherulites and can be varied in shape and size with amorphous areas between the crystallites. The length of polymers contributes to their ability to crystallize as the chains pack closely together, as well as overlapping and aligning the atoms of the molecules in a repeating lattice structure. Polymers with a backbone of carbon and oxygen, such as acetals, readily crystallize. Plastic materials, such as nylon and other polyamides, crystallize due to the parallel chains and strong hydrogen bonds of the carbonyl and amine groups. Polyethylene is crystalline because the chains are highly regular and easily aligned. Polytetrafluoroethylene (PTFE) is also highly symmetric with fluorine atoms replacing all the hydrogens along the carbon backbone. It, too, is highly crystalline. Isomer structures also affect the degree of crystallinity.

As the atactic stereochemistry results in amorphous polymers, those that are isotactic and syndiotactic result in crystalline structures, forming as chains align to form crystallites. These stereospecific forms or propylene are those which are preferable for structural applications due to their degree of crystallinity. The degree of crystallinity affects many polymeric properties. In turn, other characteristics and processes affect the degree of crystallinity. The higher the molecular weight, the lower the degree of crystallinity and the areas of the crystallites are more imperfect. The degree of crystallinity also depends on the time available for crystallization to occur. Processors can use this time to their advantage by quenching or annealing to control the time for crystallization to occur. Highly branched polymers tend to have lower degrees of crystallinity, as is easily seen in the difference between branched low-density polyethylene (LDPE) and the more crystalline high-density polyethylene (HDPE). LDPE is more flexible, less dense and more transparent than HDPE. This is an excellent example that the same polymer can have varied degrees of crystallinity. Stress can also result in crystallinity as polymer chains align orienting the crystallites. Drawing fibers, the direction of extrusion and gate placements will also affect the orientation of polymers and therefore the crystallites of the material. This allows the processor to maximize the effects and benefits of the inherent crystallinity of the polymer being used in the application. Amorphous polymers have inherent characteristics desirable for the process, methods, and resulting vessels or containers of the disclosed concept, including natural heat tolerance and molding capacity, and good water barrier from or through the material.

### PECVD Coating Layers

As discussed above, use of uncoated polymer vials for lyophilization and/or primary packaging for liquid or frozen injectables may be limited due to insufficient barrier properties of the polymer material alone. In addition, uncoated polymer vials may tend to adsorb liquid contents or cause liquid contents to wick up the vial wall, thus preventing the contents from being fully removed or aspirated, e.g., with a syringe. This can be problematic, particularly for biologic drugs, in part because they are very expensive. Wasting even a small amount of such drugs can result in significant financial loss, especially at a commercial scale. The structural configuration of the vial of the disclosed concept, particularly the substantially conical or frustoconical interior shape, as discussed above, advantageously assists in facilitating extraction of all contents (by allowing the liquid drug to pool in the bottom of the inwardly tapered or rounded inner base) and enables filling of essentially the precise volume needed for administration of a single dose. In addition, it is preferred that the internal surface 134 of the vial 110 includes a surface treatment, coating or coating set that is compatible with biologics (e.g., protein or nucleic acid based biologics) and that helps to keep the liquid at the bottom of the vial 110, rather than stuck to the sides, to reduce loss. The various coatings discussed below may be used for this purpose.

Accordingly, in an optional aspect, the disclosed concept includes a PECVD coating or PECVD coating set deposited onto one or more surfaces 130, 132, 134, of the vial 110. As stated above, the vial 110 is preferably made from a thermoplastic material. Optionally, the vial according to any embodiment is made from an injection moldable thermoplastic material as defined above, in particular a material that appears clear and glass-like in final form, e.g., a cyclic olefin polymer (COP), cyclic olefin copolymer (COC) or polycarbonate. Such materials may be manufactured, e.g., by injection molding, to very tight and precise tolerances (generally much tighter than achievable with glass). This is a benefit when trying to balance the competing considerations of seal tightness and low plunger force in plunger design. Optionally, if made from an injection moldable thermoplastic material that appears clear and glass-like in final form, the vial 110 has optical clarity for visual particle inspection of drug product stored in the product compartment. The PECVD coating or coating set is also optically clear, such that it would not disturb the aforementioned optical clarity of the vial.

As noted above, it may be desired to provide one or more coatings or layers to a surface (e.g., 130, 132 and/or 134) of a parenteral container to modify the properties of that container. For example, one or more coatings or layers may be added to a parenteral container, e.g., to improve the barrier properties of the container and prevent interaction between the container wall (or an underlying coating) and drug product held within the container. The coating(s) may alternatively or additionally prevent the liquid drug product from being adsorbed by or sticking to the internal surface 134 in the product compartment 124. Such coatings or layers may be constructed in accordance with the teachings of PCT/US 2014/023813, which is incorporated by reference herein in its entirety. Preferred methods of applying one or more of a barrier layer and underlying lie layer to the inner surface of a vessel (e.g., vial) is by plasma enhanced chemical vapor deposition (PECVD), such as described in, e.g., U.S. Pat. App. Pub. No. 20130291632, U.S. Pat. No. 7,985,188, and/or PCT/US2016/047622, each of which is incorporated by reference herein in its entirety.

### Tri-Layer Coating Set

Optionally, in any embodiment the internal surface 134 of a vial according to an aspect of the disclosed concept may include a coating set comprising one or more coatings or layers. The vial may optionally include at least one tie coating or layer, at least one barrier coating or layer, and at least one organo-siloxane coating or layer. The organo-siloxane coating or layer preferably has pH protective properties. This embodiment of the coating set is sometimes referred to herein as a “tri-layer coating set” in which the barrier coating or layer is protected against contents having a pH otherwise high enough to remove it by being sandwiched between the pH protective organo-siloxane coating or layer and the tie coating or layer. The contemplated thicknesses of the respective layers in nanometers (preferred ranges in parentheses) are given in the following Tri-layer Thickness Table:

TABLE 1
Tri-layer Thickness

| Adhesion (nm) | Barrier (nm) | Protection (nm) |
|---|---|---|
| 5-100 | 20-200 | 50-500 |
| (5-20) | (20-30) | (100-200) |

Properties, compositions and methods for generating of each of the coatings that make up the tri-layer coating set are described in U.S. Pat. No. 9,937,099, which is incorporated-by-reference herein in its entirety.

The tie coating or layer has at least two functions. One function of the tie coating or layer is to improve adhesion of a barrier coating or layer to a substrate (e.g., the inner surface of the vial), in particular a thermoplastic substrate, although a tie layer can be used to improve adhesion to a glass substrate or to another coating or layer. For example, a tie coating or layer, also referred to as an adhesion layer or coating can be applied to the substrate and the barrier layer can be applied to the adhesion layer to improve adhesion of the barrier layer or coating to the substrate.

Another function of the tie coating or layer has been discovered: a tie coating or layer applied under a barrier coating or layer can improve the function of a pH protective organo-siloxane coating or layer applied over the barrier coating or layer.

The tie coating or layer can be composed of, comprise, or consist essentially of SiOₓC_{y}, in which x is between 0.5 and 2.4 and y is between 0.6 and 3. Alternatively, the atomic ratio can be expressed as the formula SiwOxCy. The atomic ratios of Si, O, and C in the tie coating or layer are, as several options:
Si 100:O 50-150:C 90-200 (i.e. w=1, x=0.5 to 1.5, y=0.9 to 2);
Si 100:O 70-130:C 90-200 (i.e. w=1, x=0.7 to 1.3, y=0.9 to 2)
Si 100:O 80-120:C 90-150 (i.e. w=1, x=0.8 to 1.2, y=0.9 to 1.5)
Si 100:O 90-120:C 90-140 (i.e. w=1, x=0.9 to 1.2, y=0.9 to 1.4), or
Si 100:O 92-107:C 116-133 (i.e. w=1, x=0.92 to 1.07, y=1.16 to 1.33).

The atomic ratio can be determined by XPS. Taking into account the H atoms, which are not measured by XPS, the tie coating or layer may thus in one aspect have the formula SiwOxCyHz (or its equivalent SiOxCy), for example where w is 1. x is from about 0.5 to about 2.4, y is from about 0.6 to about 3, and z is from about 2 to about 9. Typically, a tie coating or layer would hence contain 36% to 41% carbon normalized to 100% carbon plus oxygen plus silicon.

The barrier coating or layer for any embodiment defined in this specification (unless otherwise specified in a particular instance) is a coating or layer, optionally applied by PECVD as indicated in U.S. Pat. No. 7,985,188. The barrier coating preferably is characterized as a “SiOx” coating, in which x, the ratio of oxygen to silicon atoms, is from about 1.5 to about 2.9. The thickness of the SiOx or other barrier coating or layer can be measured, for example, by transmission electron microscopy (TEM), and its composition can be measured by X-ray photoelectron spectroscopy (XPS). The barrier layer is effective to prevent oxygen, carbon dioxide, water vapor, or other gases (e.g., residual monomers of the polymer from which the container wall is made) from entering the container and/or to prevent leaching of the pharmaceutical material into or through the container wall.

The Applicant has found that barrier layers or coatings of SiOx are eroded or dissolved by some fluids, for example aqueous compositions having a pH above about 5. Since coatings applied by chemical vapor deposition can be very thin—tens to hundreds of nanometers thick—even a relatively slow rate of erosion can remove or reduce the effectiveness of the barrier layer in less time than the desired shelf life of a product package. This is particularly a problem for fluid pharmaceutical compositions, since many of them have a pH of roughly 7, or more broadly in the range of 5 to 9, similar to the pH of blood and other human or animal fluids. The higher the pH of the pharmaceutical preparation, the more quickly it erodes or dissolves the SiOx coating. Optionally, this problem can be addressed by protecting the harrier coating or layer, or other pH sensitive material, with a pH protective organo-siloxane coating or layer.

Optionally, the pH protective coating or layer can be composed of, comprise, or consist essentially of SiwOxCyHz (or its equivalent SiOxCy) or SiwNxCyHz or its equivalent SiNxCy). The atomic ratio of Si:O:C or Si:N:C can be determined by XPS (X-ray photoelectron spectroscopy). Taking into account the H atoms, the pH protective coating or layer may thus in one aspect have the formula SiwOxCyHz, or its equivalent SiOxCy, for example where w is 1, x is from about 0.5 to about 2.4, y is from about 0.6 to about 3, and z is from about 2 to about 9.

Typically, expressed as the formula SiwOxCy, the atomic ratios of Si, O, and C are, as several options:
Si 100:O 50-150:C 90-200 (i.e. w=1, x=0.5 to 1.5, y=0.9 to 2);
Si 100:O 70-130:C 90-200 (i.e. w=1, x=0.7 to 1.3, y=0.9 to 2)
Si 100:O 80-120:C 90-150 (i.e. w=1, x=0.8 to 1.2, y=0.9 to 1.5)
Si 100:O 90-120:C 90-140 (i.e. w=1, x=0.9 to 1.2, y=0.9 to 1.4)
Si 100:O 92-107:C 116-133 (i.e. w=1, x=0.92 to 1.07, y=1.16 to 1.33),
or
Si 100:O 80-130:C 90-150.

Alternatively, the organo-siloxane coating or layer can have atomic concentrations normalized to 100% carbon, oxygen, and silicon, as determined by X-ray photoelectron spectroscopy (XPS) of less than 50% carbon and more than 25% silicon. Alternatively, the atomic concentrations arc from 25 to 45% carbon, 25 to 65% silicon, and 10 to 35% oxygen. Alternatively, the atomic concentrations are from 30 to 40% carbon, 32 to 52% silicon, and 20 to 27% oxygen. Alternatively, the atomic concentrations are from 33 to 37% carbon, 37 to 47% silicon, and 22 to 26% oxygen.

Optionally, the atomic concentration of carbon in the pH protective coating or layer, normalized to 100% of carbon, oxygen, and silicon, as determined by X-ray photoelectron spectroscopy (XPS), can be greater than the atomic concentration of carbon in the atomic formula for the organosilicon precursor. For example, embodiments are contemplated in which the atomic concentration of carbon increases by from 1 to 80 atomic percent, alternatively from 10 to 70 atomic percent, alternatively from 20 to 60 atomic percent, alternatively from 30 to 50 atomic percent, alternatively from 35 to 45 atomic percent, alternatively from 37 to 41 atomic percent.

Optionally, the atomic ratio of carbon to oxygen in the pH protective coating or layer can be increased in comparison to the organosilicon precursor, and/or the atomic ratio of oxygen to silicon can be decreased in comparison to the organosilicon precursor.

An exemplary empirical composition for a pH protective coating according to an optional embodiment is SiO_{1.3}C_{0.8}H_{3.6}.

Optionally in any embodiment, the pH protective coating or layer comprises, consists essentially of, or consists of PECVD applied coating.

Optionally in any embodiment, the pH protective coating or layer is applied by employing a precursor comprising, consisting essentially of, or consisting of a silane. Optionally in any embodiment, the silane precursor comprises, consists essentially of, or consists of any one or more of an acyclic or cyclic silane, optionally comprising, consisting essentially of, or consisting of any one or more of silane, trimethylsilane, tetramethylsilane, Si2-Si4 silanes, triethyl silane, tetraethyl silane, tetrapropylsilane, tetrabutylsilane, or octamethylcyclotetrasilane, or tetramethylcyclotetrasilane.

Optionally in any embodiment, the pH protective coating or layer comprises, consists essentially of, or consists of PECVD applied amorphous or diamond-like carbon. Optionally in any embodiment, the amorphous or diamond-like carbon is applied using a hydrocarbon precursor. Optionally in any embodiment, the hydrocarbon precursor comprises, consists essentially of, or consists of a linear, branched, or cyclic alkane, alkene, alkadiene, or alkyne that is saturated or unsaturated, for example acetylene, methane, ethane, ethylene, propane, propylene, n-butane, butane, butane, propyne, butyne, cyclopropane, cyclobutane, cyclohexane, cyclohexene, cyclopentadiene, or a combination of two or more of these. Optionally in any embodiment, the amorphous or diamond-like carbon coating has a hydrogen atomic percent of from 0.1% to 40%, alternatively from 0.5% to 10%, alternatively from 1% to 2%, alternatively from 1.1 to 1.8%

Optionally in any embodiment, the pH protective coating or layer comprises, consists essentially of, or consists of PECVD applied SiN. Optionally in any embodiment, the PECVD applied SiN is applied using a silane and a nitrogen-containing compound as precursors. Optionally in any embodiment, the silane is an acyclic or cyclic silane, optionally comprising, consisting essentially of, or consisting of silane, trimethylsilane, tetramethylsilane, Si2-Si4 silanes, triethylsilane, tetraethylsilane, tetrapropylsilane, tetrabutylsilane, octamethylcyclotetrasilane, or a combination of two or more of these. Optionally in any embodiment, the nitrogen-containing compound comprises, consists essentially of, or consists of any one or more of: nitrogen gas, nitrous oxide, ammonia or a silazane. Optionally in any embodiment, the silazane comprises, consists essentially of, or consists of a linear silazane, for example hexamethylene disilazane (HMDZ), a monocyclic silazanc, a polycyclic silazanc, a polysilscsquiazanc, or a combination of two or more of these.

Optionally in any embodiment, the PECVD for the pH protective coating or layer is carried out in the substantial absence or complete absence of an oxidizing gas. Optionally in any embodiment, the PECVD for the pH protective coating or layer is carried out in the substantial absence or complete absence of a carrier gas.

Optionally an FTIR absorbance spectrum of the pH protective coating or layer SiOxCyHz has a ratio greater than 0.75 between the maximum amplitude of the Si—O—Si symmetrical stretch peak normally located between about 1000 and 1040 cm-1, and the maximum amplitude of the Si—O—Si asymmetric stretch peak normally located between about 1060 and about 1100 cm-1. Alternatively in any embodiment, this ratio can be at least 0.8, or at least 0.9, or at least 1.0, or at least 1.1, or at least 1.2. Alternatively in any embodiment, this ratio can be at most 1.7, or at most 1.6, or at most 1.5, or at most 1.4, or at most 1.3. Any minimum ratio stated here can be combined with any maximum ratio stated here, as an alternative embodiment.

Optionally, in any embodiment the pH protective coating or layer, in the absence of the liquid filling, has a non-oily appearance. This appearance has been observed in some instances to distinguish an effective pH protective coating or layer from a lubricity layer (e.g., as described in U.S. Pat. No. 7,985,188), which in some instances has been observed to have an oily (i.e. shiny) appearance.

The pH protective coating or layer optionally can be applied by plasma enhanced chemical vapor deposition (PECVD) of a precursor feed comprising an acyclic siloxane, a monocyclic siloxane, a polycyclic siloxane, a polysilsesquioxane, a monocyclic silazanc, a polycyclic silazane, a polysilsesquiazane, a silatrane, a silquasilatrane, a silproatrane, an azasilatrane, an azasilquasiatrane, an azasilproatrane, or a combination of any two or more of these precursors. Some particular, non-limiting precursors contemplated for such use include octamethylcyclotetrasiloxane (OMCTS).

Other precursors and methods can be used to apply the pH protective coating or layer or passivating treatment. For example, hexamethylene disilazane (HMDZ) can be used as the precursor. HMDZ has the advantage of containing no oxygen in its molecular structure. This passivation treatment is contemplated to be a surface treatment of the SiOx barrier layer with HMDZ. To slow down and/or eliminate the decomposition of the silicon dioxide coatings at silanol bonding sites, the coating must be passivated. It is contemplated that passivation of the surface with HMDZ (and optionally application of a few mono layers of the HMDZ-derived coating) will result in a toughening of the surface against dissolution, resulting in reduced decomposition. It is contemplated that HMDZ will react with the —OH sites that are present in the silicon dioxide coating, resulting in the evolution of NH₃ and bonding of S—(CH₃)₃ to the silicon (it is contemplated that hydrogen atoms will be evolved and bond with nitrogen from the HMDZ to produce NH₃).

Another way of applying the pH protective coating or layer is to apply as the pH protective coating or layer an amorphous carbon or fluorocarbon coating, or a combination of the two.

Amorphous carbon coatings can be formed by PECVD using a saturated hydrocarbon, (e.g. methane or propane) or an unsaturated hydrocarbon (e.g. ethylene, acetylene) as a precursor for plasma polymerization. Fluorocarbon coatings can be derived from fluorocarbons (for example, hexafluoroethylene or tetrafluoroethylene). Either type of coating, or a combination of both, can be deposited by vacuum PECVD or atmospheric pressure PECVD. It is contemplated that that an amorphous carbon and/or fluorocarbon coating will provide better passivation of an SiOx barrier layer than a siloxane coating since an amorphous carbon and/or fluorocarbon coating will not contain silanol bonds.

It is further contemplated that fluorosilicon precursors can be used to provide a pH protective coating or layer over a SiOx barrier layer. This can be carried out by using as a precursor a fluorinated silane precursor such as hexafluorosilane and a PECVD process. The resulting coating would also be expected to be a non-wetting coating.

Yet another coating modality contemplated for protecting or passivating a SiOx barrier layer is coating the barrier layer using a polyamidoamine epichlorohydrin resin. For example, the barrier coated part can be dip coated in a fluid polyamidoamine epichlorohydrin resin melt, solution or dispersion and cured by autoclaving or other heating at a temperature between 60 and 100° C. It is contemplated that a coating of polyamidoamine epichlorohydrin resin can be preferentially used in aqueous environments between pH 5-8, as such resins are known to provide high wet strength in paper in that pH range. Wet strength is the ability to maintain mechanical strength of paper subjected to complete water soaking for extended periods of time, so it is contemplated that a coating of polyamidoamine epichlorohydrin resin on a SiOx barrier layer will have similar resistance to dissolution in aqueous media. It is also contemplated that, because polyamidoamine epichlorohydrin resin imparts a lubricity improvement to paper, it will also provide lubricity in the form of a coating on a thermoplastic surface made of, for example, COC or COP.

Even another approach for protecting a SiOx layer is to apply as a pH protective coating or layer a liquid-applied coating of a polyfluoroalkyl ether, followed by atmospheric plasma curing the pH protective coating or layer. For example, it is contemplated that the process practiced under the trademark TriboGlide® can be used to provide a pH protective coating or layer that also provides lubricity.

Thus, a pH protective coating for a thermoplastic vessel wall according to an aspect of the invention may comprise, consist essentially of, or consist of any one of the following: plasma enhanced chemical vapor deposition (PECVD) applied coating having the formula SiOxCyHz, in which x is from 0 to 0.5, alternatively from 0 to 0.49, alternatively from 0 to 0.25 as measured by X ray photoelectron spectroscopy (XPS), y is from about 0.5 to about 1.5, alternatively from about 0.8 to about 1.2, alternatively about 1, as measured by XPS, and z is from 0 to 2 as measured by Rutherford Backscattering Spectrometry (RBS), alternatively by Hydrogen Forward Scattering Spectrometry (HFS); or PECVD applied amorphous or diamond-like carbon, CHz, in which z is from 0 to 0.7, alternatively from 0.005 to 0.1, alternatively from 0.01 to 0.02; or PECVD applied SiNb, in which b is from about 0.5 to about 2.1, alternatively from about 0.9 to about 1.6, alternatively from about 1.2 to about 1.4, as measured by XPS.

Optionally, in any embodiment, a top surface treatment or coating is applied atop the pH protective layer to optimize the compatibility of the vial surface with specific drugs. Such surface treatment or coating eliminates liquid hang-up on the vial walls that may cause small amounts of the drug to be lyophilized on the wall, which is unattractive and may result in rejected product.

### PECVD Apparatus

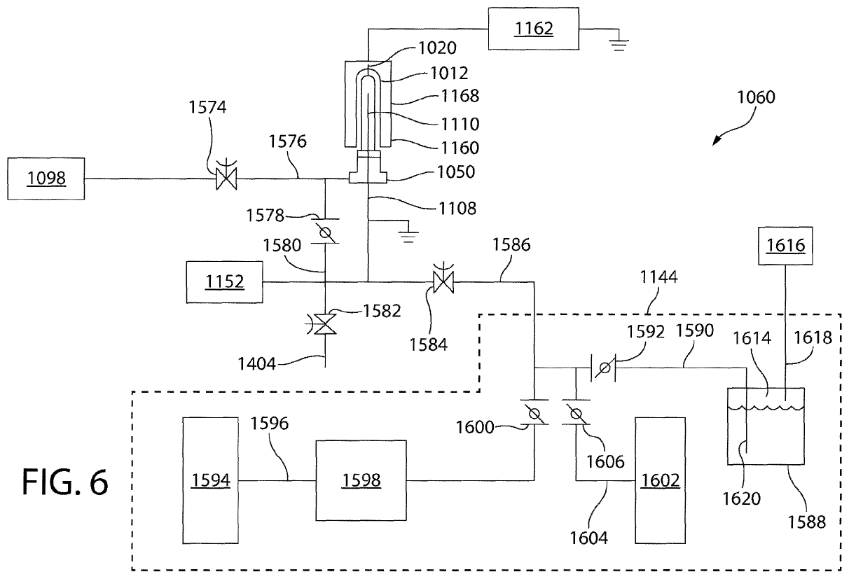

PECVD apparatus suitable for applying any of the PECVD coatings or layers described in this specification, including the tie coating or layer, the barrier coating or layer or the organo-siloxane coating or layer, are shown and described in U.S. Pat. No. 7,985,188 and U.S. Pat. App. Pub. No. 20130291632. This apparatus optionally includes a vessel holder, an inner electrode, an outer electrode, and a power supply. A vessel seated on the vessel holder defines a plasma reaction chamber, optionally serving as its own vacuum chamber. Optionally, a source of vacuum, a reactant gas source, a gas feed or a combination of two or more of these can be supplied. Optionally, a gas drain, not necessarily including a source of vacuum, is provided to transfer gas to or from the interior of a vessel seated on the port to define a closed chamber. Additional details of optional PECVD apparatus and use of the same to apply coatings follows, with reference to FIG. 6.

A PECVD apparatus or coating station 1060 suitable for the present purpose includes a vessel holder 1050, an inner electrode defined by the probe 1108, an outer electrode 1160, and a power supply 1162. The pre-assembly 1012 seated on the vessel holder 1050 defines a plasma reaction chamber, which optionally can be a vacuum chamber. Optionally, a source of vacuum 1098, a reactant gas source 1144, a gas feed (probe 1108) or a combination of two or more of these can be supplied.

The PECVD apparatus can be used for atmospheric-pressure PECVD, in which case the plasma reaction chamber defined by the pre-assembly 1012 does not need to function as a vacuum chamber.

The vessel holder 1050 comprises a gas inlet port for conveying a gas into the pre-assembly 1012 seated on the opening. The gas inlet port can have a sliding seal provided for example by at least one O-ring, or two O-rings in series, or three O-rings in series, which can seat against a cylindrical probe 1108 when the probe 1108 is inserted through the gas inlet port. The probe 1108 can be a gas inlet conduit that extends to a gas delivery port at its distal end 1110. The distal end 1110 of the illustrated embodiment can be inserted at an appropriate depth in the pre-assembly 1012 for providing one or more PECVD reactants and other precursor feed or process gases.

FIG. 6 shows additional optional details of the coating station 1060 that are usable, for example, with all the illustrated embodiments. The coating station 1060 can also have a main vacuum valve 1574 in its vacuum line 1576 leading to the pressure sensor 1152. A manual bypass valve 1578 can be provided in the bypass line 1580. A vent valve 1582 controls flow at the vent 1404.

Flow out of the PECVD gas or precursor source 1144 can be controlled by a main reactant gas valve 1584 regulating flow through the main reactant feed line 1586. One component of the gas source 1144 can be the organosilicon liquid reservoir 1588, containing the precursor. The contents of the reservoir 1588 can be drawn through the organosilicon capillary line 1590, which optionally can be provided at a suitable length to provide the desired flow rate. Flow of organosilicon vapor can be controlled by the organosilicon shut-off valve 1592. Pressure can be applied to the headspace 1614 of the liquid reservoir 1588, for example a pressure in the range of 0-15 psi (0 to 78 cm. Hg), from a pressure source 1616 such as pressurized air connected to the headspace 1614 by a pressure line 1618 to establish repeatable organosilicon liquid delivery that is not dependent on atmospheric pressure (and the fluctuations therein). The reservoir 1588 can be sealed and the capillary connection 1620 can be at the bottom of the reservoir 1588 to ensure that only neat organosilicon liquid (not the pressurized gas from the headspace 1614) flows through the capillary tube 1590. The organosilicon liquid optionally can be heated above ambient temperature, if necessary or desirable to cause the organosilicon liquid to evaporate, forming an organosilicon vapor. To accomplish this heating, the apparatus can advantageously include heated delivery lines from the exit of the precursor reservoir to as close as possible to the gas inlet into the vessel. Preheating can be useful, for example, when feeding OMCTS.

Oxidant gas can be provided from the oxidant gas tank 1594 via an oxidant gas feed line 1596 controlled by a mass flow controller 1598 and provided with an oxidant shut-off valve 1600.

Optionally in any embodiment, other precursor, oxidant, and/or carrier gas reservoirs such as 1602 can be provided to supply additional materials if needed for a particular deposition process. Each such reservoir such as 1602 can have an appropriate feed line 1604 and shut-off valve 1606.

The processing station 1060 can include an electrode 1160 fed by a radio frequency power supply 1162 for providing an electric field for generating plasma within the pre-assembly 1012 during processing. In this embodiment, the probe 1108 can be electrically conductive and can be grounded, thus providing a counter-electrode within the pre-assembly 1012. Alternatively, in any embodiment the outer electrode 1160 can be grounded and the probe 1108 can be directly connected to the power supply 1162.

The outer electrode 1160 can either be generally cylindrical or a generally U-shaped elongated channel. Each embodiment can have one or more sidewalls and optionally a top end 1168, disposed about the pre-assembly 1012 in close proximity.

Accordingly, in one optional aspect, the invention may incorporate an organo-siloxane coating on the inner surface of a container which may, for example, be any embodiment of the pH protective coating discussed above. The organo-siloxane coating may be applied directly to the interior wall of the container or as a lop layer on a multi-layer coating set, e.g., the tri-layer coating set discussed above.

The organo-siloxane coating can optionally provide multiple functions: (1) a pH resistant layer that protects an underlying layer or underlying polymer substrate from drug products having a pH from 4-10, optionally from 5-9; (2) a drug contact surface that minimizes aggregation, extractables and leaching; and (3) in the case of a protein-based drug, reduced protein binding on the container surface.

In one embodiment, the tie or adhesion coating or layer and the barrier coating or layer, and optionally the pH protective layer, are applied in the same apparatus, without breaking vacuum between the application of the adhesion coating or layer and the barrier coating or layer or, optionally, between the barrier coating or layer and the pH protective coating or layer. During the process, a partial vacuum is drawn in the lumen. While maintaining the partial vacuum unbroken in the lumen, a tie coating or layer of SiOxCy is applied by a tie PECVD coating process. The tie PECVD coating process is carried out by applying sufficient power to generate plasma within the lumen while feeding a gas suitable for forming the coating. The gas feed includes a linear siloxane precursor, optionally oxygen, and optionally an inert gas diluent. The values of x and y are as determined by X-ray photoelectron spectroscopy (XPS). Then, while maintaining the partial vacuum unbroken in the lumen, the plasma is extinguished. A tie coating or layer of SiOxCy, for which x is from about 0.5 to about 2.4 and y is from about 0.6 to about 3, is produced on the inside surface as a result.

Later during the process, while maintaining the partial vacuum unbroken in the lumen, a barrier coating or layer is applied by a barrier PECVD coating process. The barrier PECVD coating process is carried out by applying sufficient power to generate plasma within the lumen while feeding a gas. The gas feed includes a linear siloxane precursor and oxygen. A barrier coating or layer of SiOx, wherein x is from 1.5 to 2.9 as determined by XPS is produced between the tie coating or layer and the lumen as a result.

Then optionally, while maintaining the partial vacuum unbroken in the lumen, the plasma is extinguished.

Later, as a further option, a pH protective coating or layer of SiOxCy can be applied. In this formula as well, x is from about 0.5 to about 2.4 and y is from about 0.6 to about 3, each as determined by XPS. The pH protective coating or layer is optionally applied between the barrier coating or layer and the lumen, by a pH protective PECVD coating process. This process includes applying sufficient power to generate plasma within the lumen while feeding a gas including a linear siloxane precursor, optionally oxygen, and optionally an inert gas diluent.

Then optionally, while maintaining the partial vacuum unbroken in the lumen, the plasma is extinguished.

Later, as a further option, a lubricity coating or layer of SiOxCy can be applied. In this formula as well, x is from about 0.5 to about 2.4 and y is from about 0.6 to about 3, each as determined by XPS. The lubricity coating or layer is optionally applied on top of the pH protective coating, by a lubricity PECVD coating process. This process includes applying sufficient power to generate plasma within the lumen while feeding a gas including an organo siloxane precursor, optionally oxygen, and optionally an inert gas diluent.

Optionally in any embodiment, the PECVD process for applying the tie coating or layer, the harrier coating or layer, and/or the pH protective coating or layer, and/or the lubricty coating or any combination of two or more of these, is carried out by applying pulsed power (alternatively the same concept is referred to in this specification as “energy”) to generate plasma within the lumen.

Alternatively, the tic PECVD coating process, or the barrier PECVD coating process, or the pH protective PECVD coating process, or any combination of two or more of these, can be carried out by applying continuous power to generate plasma within the lumen.

The trilayer coating as described in this embodiment is applied by adjusting the flows of a single organosilicon monomer (HMDSO) and oxygen and also varying the PECVD generating power between each layer (without breaking vacuum between any two layers).

The vessel (e.g., a COC or COP vial) is placed on a vessel holder, sealed, and a vacuum is pulled within the vessel. After pulling vacuum, the gas feed of precursor, oxygen, and argon is introduced, then at the end of the “plasma delay” continuous (i.e. not pulsed) RF power at 13.56 MHz is turned on to form the tie coating or layer. Then power is turned off, gas flows are adjusted, and after the plasma delay power is turned on for the second layer—an SiOx harrier coating or layer. This is then repeated for a third layer before the gases are cut off, the vacuum seal is broken, and the vessel is removed from the vessel holder. The layers are put down in the order of Tie then Barrier then pH Protective. Exemplary process settings are as shown in the following table:

TABLE 2

| | O₂ | Ar | HMDSO | Power | Deposition |
|---|---|---|---|---|---|
| Coating | (sccm) | (sccm) | (sccm) | (W) | Time (sec) |
| Tie | 1 | 40 | 2 | 20 | 2.5 |
| Barrier | 100 | 0 | 1 | 60 | 15 |
| pH Protective | 1 | 40 | 2 | 20 | 10 |

As a still a still further alternative, pulsed power can be used for some steps, and continuous power can be used for others. For example, when preparing a trilayer coating or layer composed of a tie coating or layer, a barrier coating or layer, and a pH protective coating or layer, an option specifically contemplated for the tic PECVD coating process and for the pH protective PECVD coating process is pulsed power, and an option contemplated for the corresponding barrier layer is using continuous power to generate plasma within the lumen.

### PECVD Water Barrier Coating or Layer

Optionally, in any embodiment, the vial may include deposited thereon a PECVD water barrier coating or layer, as described in Applicant's WO 2019/191269, which is incorporated by reference herein in its entirety. Such a water barrier layer is particularly helpful to provide necessary barrier properties for vials made from cyclic olefin copolymers (COC) or cyclic olefin polymers (COP). COC and COP are amorphous polyolefins, so they are transparent. While COP/COC generally have good water barrier properties for thermoplastics, they may not have sufficient water barrier properties for storing lyophilized drugs, which are supersensitive to moisture.

Optionally, in any embodiment, the vial may include a PECVD water harrier layer in addition to or as an alternative to the above-described tri-layer coating set. Optionally, in any embodiment, the vial may include a PECVD water barrier layer in addition to any one or more of the individual layers of the above-described tri-layer coating set.

The PECVD water barrier layer has a water contact angle from 80 to 180 degrees, optionally from larger than 80 degrees to less than 180 degrees, optionally from 90 degrees to 160 degrees, optionally from 100 degrees to 150 degrees, optionally from 110 degrees to 150 degrees, applied to a surface of the vial using a water barrier coating or layer precursor. The precursor comprises at least one of a saturated or unsaturated, linear or cyclic aliphatic fluorocarbon precursor having from 1 to 10, optionally 1 to 6, optionally 2 to 6 carbon atoms and from 4 to 20 fluorine atoms per molecule, optionally hexafluropropylene (C₃F₆), octafluorocyclobutane (CFO, tetrafluoroethylene (C₂F₄), hexafluoroethane (C₂F₆), hexafluoropropylene (C₃F₆), octafluorocyclobutane (C₄F₈), perfluorohexane (C₆F₁₄), perfluoro-2-methyl-2-pentene (C₆F₁₂). The precursor further comprises a saturated or unsaturated hydrocarbon having from 1 to 6 carbon atoms, for example lower alkanes having from 1 to 4 carbon atoms, alkenes or alkynes having from 2 to 4 carbon atoms, for example acetylene (C₂H₂) or methane (CH₄), optionally acetylene (C₂H₂), a saturated or unsaturated hydrofluorocarbon having from 1 to 6 carbon atoms; or any combination thereof.

Optionally, in any embodiment, the water barrier layer is between the tri-layer coating and the interior surface of the vessel wall. Optionally, in any embodiment, the water barrier layer is deposited directly to the polymer interior surface of the vessel or vial.

An optional method for applying the water barrier layer and optionally additional coatings (e.g., tie layer, barrier layer and/or pH protective layer) is now described. The method includes at least partially evacuating a region adjacent to a surface of the vessel wall, forming a partially evacuated region. The method further includes feeding the water barrier coating or layer precursor to the partially evacuated region and generating a plasma in the partially evacuated region, forming a water barrier layer supported by the wall adjacent to the evacuated region. The method further includes, before or after the step of feeding the water barrier layer precursor, feeding a precursor gas for a first coating or layer of the tri-layer coating set to the partially evacuated region and generating plasma in the partially evacuated region, forming a coating or layer of the tri-layer coating set supported by the wall adjacent to the evacuated region. Optionally, the method further includes, after feeding a precursor gas for a first coating of the tri-layer coating set, feeding a precursor gas for a second coating of the tri-layer coating set to the partially evacuated region and generating plasma in the partially evacuated region, forming a second coating or layer of the gas barrier coating set supported by the wall adjacent to the evacuated region. Optionally, between at least two or three of the feeding steps, the vacuum in the evacuated region is not broken.

Optionally, the water barrier coating or layer is from 1 nm to 500 nm thick, optionally from 1 nm to 300 nm thick, optionally from 1 nm to 100 nm thick, optionally from 10 nm to 300 nm thick, optionally from 50 nm to 300 nm thick, optionally from 50 nm to 200 nm thick.

Optionally, in any embodiment, the water barrier coating or layer is in direct contact with the vessel (or vial) wall, optionally the inner surface and/or outer surface of the wall.

Optionally, in any embodiment, the water barrier coating or layer is deposited atop a tri-layer coating set on an interior surface of the vial. Optionally, in any embodiment, the tri-layer coating set is deposited atop the water barrier coating or layer on an interior surface of the vial. Optionally, in any embodiment, the vial includes a water barrier layer with no tri-layer coating set. Optionally, in any embodiment, the vial includes a tri-layer coating set with no water barrier layer.

Optionally, for the water harrier coating applied using fluorocarbons as the precursors, the typical coating process conditions are as follows:
Power frequency 13.56 MHz;
Precursor: Hexafluoropropylene (C₃F₆) or Octafluorocyclobutane (C₄F₈);
Gas flow rate: 5-10 sccm;
Carrier gas flow rate: 2-10 sccm;
Base pressure 20-300 mTorr;
Coating Pressure: 80-900 mTorr;
Coating time: 5-30 s.

Optionally, for the water barrier coating applied using hydrocarbons as the precursors, the typical coating process conditions are as follows:
Power frequency 13.56 MHz;
Precursor: Acetylene (C₂H₂);
Gas flow rate 1-10 sccm;
Carrier gas flow rate: 2-5 sccm;
Base pressure 20-300 mTorr;
Coating Pressure: 80-900 mTorr;
Coating time: 5-30 s.

An advantage of the water barrier layer on a plastic (e.g., COC or COP) vial is that the layer significantly prevents the ingress of moisture during the shelf life (e.g., two years) in which a lyophilized drug may be stored at room temperature in the vial. The lyophilized drug is supersensitive to water and thus the water barrier layer may be utilized to prevent the drug from absorbing moisture.

### Optional Use of the Vial

Optionally, the vial 110 is filled with an injectable drug either in liquid, frozen or freeze-dried (lyophilized) form. The vial 110 may contain a single dose or multiple doses. A healthcare worker transfers an injectable dose from the vial 110, optionally using a disposable syringe with a transfer needle configured to extract the drug from the vial. The needle is long enough to access the drug product at the bottom of the vial 110. The dose is transferred from the vial 110 into the syringe (optionally doses ranging from 10 microliters to 500 microliters). The syringe is then primed to position an air bubble within the barrel away from the needle end of the syringe. The transfer needle is removed from the syringe and an injection needle (optionally about 0.25 to 0.50 inch in length, optionally ranging in gauge from 20 g to 32 g, most preferably 27-29 g) is attached to the syringe so as to provide a conduit from the inside of the syringe to the outside. Next the drug is injected into the patient. If the vial 110 is intended for multiple doses, this process is repeated.

### EXAMPLES

The disclosed concept will be illustrated in more detail with reference to the following Examples, but it should be understood that the disclosed concept is not deemed to be limited thereto.

### Example 1

Vials were challenged at −70° C. and approximately −196° C. to visually qualify the thermal stability of the vials after cycling between low and ambient temperatures. After one round of cycling, there were no failures in any of the vials that were molded from COP, whereas the glass vials had multiple failures. After a total of three cycles, the 10 mL vials had the most failures (19 failures), followed by the 6 mL (two failures), 2 mL (one failure), and the “reduced volume” 0.5 mL vials (i.e., exemplary vials according to the disclosed concept) had zero failures. In order to assess the effects of fill volume on the vials, 10 mL COP, 10 mL COC, and 10 mL glass vials were filled with 6.5 mL of water and subjected to temperature cycling at −70° C. There were zero (0) failures for the COP and COC vials, whereas the glass vials had failures even with the reduced volume of liquid.

Five (5) types of vials varying in volume were subjected to multiple freeze-thaw cycles to assess the thermal stability of each molded geometry. One set of vials was cycled between −70° C. and 25° C. and another set from approximately −196° C. to room temperature. This type of challenge was meant to assess the efficacy of the parts to maintain structural integrity after cold storage. Cycling between very low temperatures and ambient temperature causes the molecules in the vials to expand and contract, potentially introducing fractures in the structure of the vial. The vial formats used for this study were the prototype “reduced volume” 0.5 Ml vial, standard volume 2 mL, 6 mL, and 10 mL vials made from COP and an 8 mL glass vial.

A third condition was tested to assess the effects of fill volumes on 10 mL COP, 10 mL COC, 10 mL Schott glass vials, and 8 mL OMPI glass vials. All vials were filled with 6.5 mL of water and challenged to three cycles at −70° C.

A single cycle was defined as a 24-hour soak at low temperature, followed by a 24-hour soak at 25° C. or room temperature. For the purposes of this report, any crack or defect observed after each cycle was classified as a failure.

### Experiment 1: Thermal Stability with Nominal Fill

For each temperature cycle, 10 vials were left empty but stoppered and sealed with an aluminum crimp, and 20 vials were filled with Milli-Q water then stoppered and sealed with an aluminum crimp. In all vial formats, except the reduced volume 0.5 mL, the fill volumes were selected based on where the top of the fill line would be resting at the vial's shoulder in order to simulate a maximum fill scenario. In the case of the reduced volume 0.5 mL, the design does not include a traditional “shoulder” internally, so the volume was selected based on the intended use of 0.5 mL. See Table 3 below for exact fill volumes used.

TABLE 3

| | | Fill | |
|---|---|---|---|
| Vial Format | Closure | Vol. (mL) | Mfg. |
| Reduced volume | 13 mm West | 0.5 | SiO2 |
| 0.5 mL-COP | NovaPure 4032 + VWR | | Materials |
| | Aluminum Crimp | | Science |
| 2 mL-COP | 13 mm West | 2.5 | SiO2 |
| | NovaPure 4032 + VWR | | Materials |
| | Aluminum Crimp | | Science |
| 6 mL-COP | 20 mm West | 6.5 | SiO2 |
| | NovaPure 4032 + VWR | | Materials |
| | Aluminum Crimp | | Science |
| 10 mL-COP | 20 mm West | 9.0 | SiO2 |
| | NovaPure 4032 + VWR | | Materials |
| | Aluminum Crimp | | Science |
| 8 mL-Glass | 20 mm West | 8.0 | Ompi |
| | NovaPure 4032 + VWR | | |
| | Aluminum Crimp | | |

Some vial samples were subjected to “Condition A” cycling and other vial samples were subjected to “Condition B” cycling. Vials that underwent Condition A cycling were put into a temperature-controlled chamber with an initial temperature of −70° C. The chamber was set to automatically cycle between −70° C. and 25° C. with a 24-hour soak time at each temperature setting and a 15-minute ramp time between settings. A total of three (3) cycles were performed and after each cycle, the vials were visually inspected for gross cracks or defects (failure). A single cycle was defined as a 24-hour soak at −70° C. followed by a 15-minute ramp and a 24-hour soak at 25° C.

Vials that underwent Condition B cycling were put into metal cannisters and then placed inside of a partially filled liquid nitrogen (N₂) dewar and secured so that they only came into contact with the vapor phase of the N₂. The temperature was monitored and reached −194° C. each cycle. After each 24-hour soak in the liquid nitrogen dewar, the vial cannisters were removed and placed on the floor at ambient conditions for 24 hours. A total of three (3) cycles were performed and after each cycle, the vials were visually inspected for gross cracks or defects (failure). A single cycle was defined as a 24-hour soak at approximately −196° C., followed by an immediate 24-hour soak at room temperature (RT).

The results of the experiment with vials cycled under Condition A are summarized in table 4, below:

TABLE 4
Number of Failures Under Condition A

| | | Cycle 1 | Cycle 2 | Cycle 3 | Total |
|---|---|---|---|---|---|
| Test | | # of | # of | # of | # of |
| Samples | n | failures | failures | failures | failures |
| Reduced | 20 Filled | Filled-0 | Filled-0 | Filled-0 | Filled-0 |
| volume | 10 Empty | Empty-0 | Empty-0 | Empty-0 | Empty-0 |
| 0.5 mL | | | | | |
| COP Vial | | | | | |
| 2 mL | 20 Filled | Filled-0 | Filled-0 | Filled-0 | Filled-0 |
| COP Vial | 10 Empty | Empty-0 | Empty-0 | Empty-0 | Empty-0 |
| 6 mL | 20 Filled | Filled-0 | Filled-0 | Filled-0 | Filled-0 |
| COP Vial | 10 Empty | Empty-0 | Empty-0 | Empty-0 | Empty-0 |
| 10 mL | 20 Filled | Filled-0 | Filled-3 | Filled-6 | Filled-9 |
| COP Vial | 10 Empty | Empty-0 | Empty-0 | Empty-1 | Empty-1 |
| 8 mL | 20 Filled | Filled-2 | Filled-7 | Filled-10 | Filled-19 |
| Glass Vial | 10 Empty | Empty-0 | Empty-1 | Empty-0 | Empty-1 |

There were no observable defects after Cycle #1 for any of the COP vials, but two filled glass vials were completely shattered. For Cycle #2, three of the filled 10 mL vials had small cracks on the bottom that did not extend to the outer diameter of the vial. Seven of the filled and one empty glass vial were shattered. The remaining vials made from the COP had no observable defects. In Cycle #3, six of the filled 10 mL vials had fractures or other defects. Four of the vials had cracks along the entire bottom of the vial and two of the vials had small cracks that radiated from the bottom center of the vial. Ten of the filled glass vials were completely shattered after the third round of cycling. The remaining vials made from the COP resin had no observable defects. There were no observable defects or failures of any of the COP vials after one round of temperature cycling at −70° C. and 25° C., whereas there were two glass vials that failed. At the end of all three cycles, there were a total of 20 failures of the glass vials, ten failures of the 10 mL COP vials, and no observable failures for the reduced volume 0.5 mL, 2 mL, or 6 mL COP vials.

The results of the experiment with vials cycled under Condition B are summarized in table 5, below:

TABLE 5
Number of Failures Under Conditions B

| | | Cycle 1 | Cycle 2 | Cycle 3 | Total |
|---|---|---|---|---|---|
| Test | | # of | # of | # of | # of |
| Samples | n | failures | failures | failures | failures |
| Reduced | 20 Filled | Filled-0 | Filled-0 | Filled-0 | Filled-0 |
| volume | 10 Empty | Empty-0 | Empty-0 | Empty-0 | Empty-0 |
| 0.5 mL | | | | | |
| COP Vial | | | | | |
| 2 mL | 20 Filled | Filled-0 | Filled-1 | Filled-0 | Filled-1 |
| COP Vial | 10 Empty | Empty-0 | Empty-0 | Empty-0 | Empty-0 |
| 6 mL | 20 Filled | Filled-0 | Filled-2 | Filled-0 | Filled-2 |
| COP Vial | 10 Empty | Empty-0 | Empty-0 | Empty-0 | Empty-0 |
| 10 mL | 20 Filled | Filled-0 | Filled-1 | Filled-4 | Filled-5 |
| COP Vial | 10 Empty | Empty-0 | Empty-0 | Empty-0 | Empty-0 |
| 8 mL | 20 Filled | Filled-5 | Discon- | Discon- | Discon- |
| Glass Vial | 10 Empty | Empty-2 | tinued | tinued | tinued |

There were no observable defects after Cycle #1 for any of the vials made from COP, but there were 5 filled glass vials, and 2 empty glass vials that were completely shattered. The glass vials were not continued in this condition since the glass was shattering in the dewar, and the fragments were not able to be cleaned out of the chamber easily. For Cycle #2, one filled 2 mL vial, 10 mL vial and two 6 mL vials had small cracks on the bottom center of the vials. The cracks did not reach the outer diameter of the bottom of the vials. The remaining vials had no observable defects. Regarding Cycle #3, four of the filled 10 mL vials had large cracks on the bottom of the vials that extended to the outer diameter and walls of the vial. The remaining vials had no observable defects. There were no observable defects or failures of any of the COP vials after one round of temperature cycling between the Nitrogen chamber (approximately −196° C.) to room temperature, whereas there were seven glass vials that failed. At the end of all three cycles, there were a total of one 2 mL, two 6 mL, and five 10 mL COP vials that failed.

### Experiment 2: Thermal Stability with Reduced Fill

Fifty of each vial type listed in table 6, below, was filled with 6.5 mL of MilliQ water then stoppered and sealed with an aluminum crimp. All of the vials were placed in a chamber that was set to −70° C. The vials were left in the −70° C. chamber for 24 hours and removed immediately to room temperature without any ramp time. A total of three (3) cycles were performed and after each cycle, the vials were visually inspected for gross cracks or defects (failure). A single cycle was defined as a 24-hour soak at −70° C. followed by a 12-hour soak at 25° C.

TABLE 6

| | | Fill | |
|---|---|---|---|
| Vial Format | Closure | Vol. (mL) | Mfg. |
| 10 mL-COP | 20 mm West | 6.5 | SiO2 |
| | NovaPure 4032 + VWR | | Materials |
| | Aluminum Crimp | | Science |
| 10 mL-COC | 20 mm West | 6.5 | SiO2 |
| | NovaPure 4032 + VWR | | Materials |
| | Aluminum Crimp | | Science |
| 10 mL-Glass | 20 mm West | 6.5 | Schott |
| | NovaPure 4032 + VWR | | |
| | Aluminum Crimp | | |
| 8 mL-Glass | 20 mm West | 6.5 | Ompi |
| | NovaPure 4032 + VWR | | |
| | Aluminum Crimp | | |

None of the 10 mL COP vials or 10 mL COC vials had any failures observed after all three low temperature cycles. The 10 mL Schott glass vials had gross failures starting at the second cycle of thermal cycling. The 8 mL OMPI glass vials had gross failures after the first round of low temperature cycling.

As shown in these experiments, after one round of cycling at both −70° C. and −196° C., there were no failures in any of the vials that were molded from COP, whereas the glass vials had multiple failures. Of the COP vials, after a total of cycles the 10 mL vials had the most failures (19 failures), followed by the 6 mL (two failures), 2 mL (one failure), and the “reduced volume” 0.5 mL vials had zero failures. The 10 mL COP and COC vials that were subjected to thermal cycling at −70° C. for 3 rounds with a reduced fill of 6.5 mL had zero failures, whereas the glass vials (10 mL and 8 mL) had multiple failures after one round of low temperature cycling.

In sum, this example demonstrates the reliability of the reduced volume cyclic olefin vial subjected to repeated cycles of cryogenic freezing.

While the invention has been described in detail and with reference to specific examples thereof, it will be apparent to one skilled in the art that various changes and modifications can be made therein without departing from the spirit and scope thereof.

What is claimed is:

1. A vial comprising an external base and an external sidewall extending up from the external base, the external sidewall narrowing at an upper section of the vial to form a neck, the neck leading to a rim surrounding an opening providing access to a product compartment, the external base, the external sidewall, the neck and optionally the rim together defining an outer profile of the vial, the outer profile being preferably round and symmetrical about a central axis, the vial further comprising an internal sidewall that is spaced radially inward relative to the external sidewall such that a void exists between the internal sidewall and the external sidewall, the internal sidewall preferably extending from an internal portion of the neck, downward to an internal base, the internal sidewall and internal base forming an enclosure that defines the product compartment.

2. The vial of claim 1, the external base, the external sidewall, the neck and the rim together defining the outer profile, the vial being round and symmetrical about the central axis, the internal sidewall extending from the internal portion of the neck.

3. The vial of claim 1 or 2, wherein the vial is made from a thermoplastic material and is optionally formed by injection molding.

4. The vial of any previous claim, wherein the outer profile has dimensions that comply with ISO 8362-7:2006.

5. The vial of claim 4, wherein the vial is provided in provided in an ISO standard 2R format, optionally in an ISO standard 4R format, optionally in an ISO standard 5R format, optionally in an ISO standard 6R format, optionally in an ISO standard 10R format, optionally in an ISO standard 15R format, optionally in an ISO standard 20R format, optionally in an ISO standard 30R format, optionally in an ISO standard 50R format, optionally in an ISO standard 100R format.

6. The vial of any previous claim, wherein the product compartment is in fluid communication with a stopper cavity located directly above the product compartment, the stopper cavity being defined by a portion of the vial located inward of the neck and optionally the rim, the stopper cavity being configured and sized to receive a portion of a stopper to seal the vial.

7. The vial of any previous claim wherein the vial is made from an olefin polymer or copolymer, optionally cyclic olefin polymer, cyclic olefin copolymer, polyethylene and/or polypropylene.

8. The vial of claim 7, wherein the vial is made from cyclic olefin polymer or cyclic olefin copolymer.

9. The vial of any previous claim, wherein the product compartment is conical, frustoconical, or substantially conical in profile.

10. The vial of any previous claim, wherein the product compartment is configured to store precisely 0.50 mL of product and optionally has an outer profile with standard dimensions of an ISO standard 2 mL vial.

11. The vial of any previous claim comprising:
an external vial surface that includes an outer surface of the external sidewall, an outer surface of the neck and an outer surface of the rim;
an internal surface that includes an inside of the product compartment and any other surface in fluid communication therewith; and
an external product compartment surface that includes an outer surface of the product compartment;
wherein, at least a portion of at least one of the external vial surface, the internal surface and the external product compartment surface comprises at least one PECVD coating or layer disposed thereon.

12. The vial of claim 11 comprising a PECVD water barrier coating or layer deposited onto at least a portion of at least one of the external vial surface, the internal surface and the external product compartment surface, the PECVD water barrier coating or layer having a water contact angle of from 80 to 180 degrees, optionally from larger than 80 degrees to less than 180 degrees, optionally from 90 degrees to 160 degrees, optionally from 100 degrees to 150 degrees, optionally from 110 degrees to 150 degrees.

13. The vial of claim 12, wherein the PECVD water barrier coating or layer is applied through a process comprising: in a PECVD apparatus, supplying a water barrier coating or layer precursor to the vial and creating a plasma using the same, the water barrier coating or layer precursor comprising at least one of a saturated or unsaturated, linear or cyclic aliphatic fluorocarbon precursor having from 1 to 10, optionally 1 to 6, optionally 2 to 6 carbon atoms and from 4 to 20 fluorine atoms per molecule, optionally hexafluropropylene (C₃F₆), octafluorocyclobutane (C₄F₈), tetrafluoroethylene (C₂F₄), hexafluoroethane (C₂F₆), hexafluoropropylene (C₃F₆), octafluorocyclobutane (C₄F₈), perfluorohexane (C₆F₁₄) or perfluoro-2-methyl-2-pentene (C₆F₁₂), the water barrier coating or layer precursor further comprising a saturated or unsaturated hydrocarbon having from 1 to 6 carbon atoms, for example lower alkanes having from 1 to 4 carbon atoms, alkenes or alkynes having from 2 to 4 carbon atoms, for example acetylene (C₂H₂) or methane (CH₄), optionally acetylene (C₂H₂), a saturated or unsaturated hydrofluorocarbon having from 1 to 6 carbon atoms, or any combination thereof.

14. The vial of any one of claims 11 to 13, comprising a PECVD tri-layer coating set deposited onto the internal surface.

15. The vial of claim 11 or 12 comprising the PECVD water barrier coating or layer deposited onto the internal surface and a PECVD tri-layer coating set deposited atop the PECVD water barrier coating or layer.

16. The vial of claim 11 or 12 comprising a PECVD tri-layer coating set deposited onto the internal surface and the PECVD water barrier coating or layer deposited atop the PECVD tri-layer coating set.

17. The vial of any previous claim further comprising a cap or stopper to fully or partially close the opening.

18. The vial of any previous claim, the internal sidewall extending from the internal portion of the neck, downward to the internal base, the internal sidewall having an inner diameter no greater than the inner diameter of the neck.

19. The vial of any previous claim, comprising a plurality of ribs running axially between the internal sidewall and external sidewall so as to occupy a portion of the void, thereby bridging the internal sidewall with the external sidewall so as to reinforce the external sidewall.

20. The vial of any previous claim, comprising a bottom cap assembled to an underside of the vial.

21. The vial of claim 20, wherein the bottom cap provides a seating surface configured to stabilize the vial when standing upon a resting surface.

22. The vial of claim 20 or 21, wherein the bottom cap is assembled to an inner surface of the external sidewall at a location adjacent to the external base, optionally by interference fit, welding, heat staking, overmolding or multi-shot injection molding.

23. The vial of any one of claims 20 to 22, wherein the bottom cap comprises a thru-hole into which the internal base protrudes and with which the internal base engages.

24. The vial of any one of claims 20 to 23, wherein the bottom cap includes a plurality of openings configured to allow sterilization gas to migrate into the void during a sterilization procedure.

25. The vial of any previous claim comprising drug contents stored in the product compartment.

26. The vial of claim 25, wherein the drug contents are in liquid, frozen or lyophilized forms.

27. The vial of claim 25 or 26, wherein the drug contents optionally comprise biologic drugs, gene therapy or viral vectors.

28. The vial of any one of claims 25 to 27, wherein the drug contents are at least one member selected from the group consisting of:
INHALATION ANESTHETICS, which optionally include:
Aliflurane; Chloroform; Cyclopropane; Desflurane (Suprane); Diethyl Ether; Enflurane (Ethrane); Ethyl Chloride; Ethylene; Halothane (Fluothane); Isoflurane (Forane, Isoflo); Isopropenyl vinyl ether; Methoxyflurane; methoxyflurane; Methoxypropane; Nitrous Oxide; Roflurane; Sevoflurane (Sevorane, Ultane, Sevoflo); Teflurane; Trichloroethylene; Vinyl Ether; and Xenon;
INJECTABLE DRUGS, which optionally include:
Ablavar (Gadofosveset Trisodium Injection); Abarelix Depot; Abobotulinumtoxin A Injection (Dysport); ABT-263; ABT-869; ABX-EFG; Accretropin (Somatropin Injection); Acetadote (Acetylcysteine Injection); Acetazolamide Injection (Acetazolamide Injection); Acetylcysteine Injection (Acetadote); Actemra (Tocilizumab Injection); Acthrel (Corticorelin Ovine Triflutate for Injection); Actummune; Activase; Acyclovir for Injection (Zovirax Injection); Adacel; Adalimumab; Adenoscan (Adenosine Injection); Adenosine Injection (Adenoscan); Adrenaclick; AdreView (Iobenguane I 123 Injection for Intravenous Use); Afluria; Ak-Fluor (Fluorescein Injection); Aldurazyme (Laronidase); Alglucerase Injection (Ceredase); Alkeran Injection (Melphalan Hcl Injection); Allopurinol Sodium for Injection (Aloprim); Aloprim (Allopurinol Sodium for Injection); Alprostadil; Alsuma (Sumatriptan Injection); ALTU-238; Amino Acid Injections; Aminosyn; Apidra; Apremilast; Alprostadil Dual Chamber System for Injection (Caverject Impulse); AMG 009; AMG 076; AMG 102; AMG 108; AMG 114; AMG 162; AMG 220; AMG 221; AMG 222; AMG 223; AMG 317; AMG 379; AMG 386; AMG 403; AMG 477; AMG 479; AMG 517; AMG 531; AMG 557; AMG 623; AMG 655; AMG 706; AMG 714; AMG 745; AMG 785; AMG 811; AMG 827; AMG 837; AMG 853; AMG 951; Amiodarone HCl Injection (Amiodarone HCl Injection); Amobarbital Sodium Injection (Amytal Sodium); Amytal Sodium (Amobarbital Sodium Injection); Anakinra; Anti-Abeta; Anti-Beta7; Anti-Beta20; Anti-CD4; Anti-CD20; Anti-CD40; Anti-IFNalpha; Anti-IL13; Anti-OX40L; Anti-oxLDS; Anti-NGF; Anti-NRP1; Arixtra; Amphadase (Hyaluronidase Inj); Ammonul (Sodium Phenylacetate and Sodium Benzoate Injection); Anaprox; Anzemet Injection (Dolasetron Mesylate Injection); Apidra (Insulin Glulisine [rDNA origin] Inj); Apomab; Aranesp (darbepoetin alfa); Argatroban (Argatroban Injection); Arginine Hydrochloride Injection (R-Gene 10); Aristocort; Aristospan; Arsenic Trioxide Injection (Trisenox); Arlicane HCl and Epinephrine Injection (Septocaine); Arzerra (Ofatumumab Injection); Asclera (Polidocanol Injection); Ataluren; Ataluren-DMD; Atenolol Inj (Tenormin I.V. Injection); Atracurium Besylate Injection (Atracurium Besylate Injection); Avastin; Azactam Injection (Aztreonam Injection); Azithromycin (Zithromax Injection); Aztreonam Injection (Azactam Injection); Baclofen Injection (Lioresal Intrathecal); Bacteriostatic Water (Bacteriostatic Water for Injection); Baclofen Injection (Lioresal Intrathccal); Bal in Oil Ampules (Dimercarprol Injection); BayHcpB; BayTet; Benadryl; Bendamustine Hydrochloride Injection (Treanda); Benztropine Mesylate Injection (Cogentin); Betamethasone Injectable Suspension (Celestone Soluspan); Bexxar; Bicillin C-R 900/300 (Penicillin G Benzathine and Penicillin G Procaine Injection); Blenoxane (Bleomycin Sulfate Injection); Bleomycin Sulfate Injection (Blenoxane); Boniva Injection (Ibandronate Sodium Injection); Botox Cosmetic (OnabotulinumloxinA for Injection); BR3-FC; Bravelle (Urofollitropin Injection); Bretylium (Bretylium Tosylate Injection); Brevital Sodium (Methohexital Sodium for Injection); Brethine; Briobacept; BTT-1023; Bupivacaine HCl; Byetta; Ca-DTPA (Pentetate Calcium Trisodium Inj); Cabazitaxel Injection (Jevtana); Caffeine Alkaloid (Caffeine and Sodium Benzoate Injection); Calcijex Injection (Calcitrol); Calcitrol (Calcijex Injection); Calcium Chloride (Calcium Chloride Injection 10%); Calcium Disodium Versenate (Edetate Calcium Disodium Injection); Campath (Altemtuzumab); Camptosar Injection (Irinotecan Hydrochloride); Canakinumab Injection (Bans); Capastat Sulfate (Capreomycin for Injection); Capreomycin for Injection (Capastat Sulfate); Cardiolite (Prep kit for Technetium Tc99 Sestamibi for Injection); Carticel; Cathflo; Cefazolin and Dextrose for Injection (Cefazolin Injection); Cefepime Hydrochloride; Cefotaxime; Ceftriaxone; Cerezyme; Carnitor Injection; Caverject; Celestone Soluspan; Celsior; Cerebyx (Fosphenytoin Sodium Injection); Ceredase (Alglucerase Injection); Ceretec (Technetium Tc99m Exametazime Injection); Certolizumab; CF-101; Chloramphenicol Sodium Succinate (Chloramphenicol Sodium Succinate Injection); Chloramphenicol Sodium Succinate Injection (Chloramphenicol Sodium Succinate); Cholestagel (Colesevelam HCL); Choriogonadotropin Alfa Injection (Ovidrel); Cimzia; Cisplatin (Cisplatin Injection); Clolar (Clofarabine Injection); Clomiphine Citrate; Clonidine Injection (Duraclon); Cogentin (Benztropine Mesylate Injection); Colistimethate Injection (Coly-Mycin M); Coly-Mycin M (Colistimethate Injection); Compath; Conivaptan Hcl Injection (Vaprisol); Conjugated Estrogens for Injection (Premarin Injection); Copaxone; Corticorelin Ovine Triflutate for Injection (Acthrel); Corvert (Ibutilide Fumarate Injection); COVID-19 vaccine, COVID-19 mRNA vaccine, Cubicin (Daptomycin Injection); CF-101; Cyanokit (Hydroxocobalamin for Injection); Cytarabine Liposome Injection (DepoCyt); Cyanocobalamin; Cytovene (ganciclovir); D.H.E. 45; Dacetuzumab; Dacogen (Decitabine Injection); Delteparin; Dantrium IV (Dantrolene Sodium for Injection); Dantrolene Sodium for Injection (Dantrium IV); Daptomycin Injection (Cubicin); Darbepoietin Alfa; DDAVP Injection (Desmopressin Acetate Injection); Decavax; Decitabine Injection (Dacogen); Dehydrated Alcohol (Dehydrated Alcohol Injection); Denosumab Injection (Prolia); Delatestryl; Delestrogen; Delteparin Sodium; Depacon (Valproate Sodium Injection); Depo Medrol (Methylprednisolone Acetate Injectable Suspension); DepoCyt (Cytarabine Liposome Injection); DepoDur (Morphine Sulfate XR Liposome Injection); Desmopressin Acetate Injection (DDAVP Injection); Depo-Estradiol; Depo-Provera 104 mg/ml; Depo-Provera 150 mg/ml; Depo-Testosterone; Dexrazoxane for Injection, Intravenous Infusion Only (Totect); Dextrose/Electrolytes; Dextrose and Sodium Chloride Inj (Dextrose 5% in 0.9% Sodium Chloride); Dextrose; Diazepam Injection (Diazepam Injection); Digoxin Injection (Lanoxin Injection); Dilaudid-HP (Hydromorphone Hydrochloride Injection); Dimercarprol Injection (Bal in Oil Ampules); Diphenhydramine Injection (Benadryl Injection); Dipyridamole Injection (Dipyridamole Injection); DMOAD; Docetaxel for Injection (Taxotere); Dolasetron Mesylate Injection (Anzemet Injection); Doribax (Doripenem for Injection); Doripenem for Injection (Doribax); Doxercalciferol Injection (Hectorol Injection); Doxil (Doxorubicin Hcl Liposome Injection); Doxorubicin Hcl Liposome Injection (Doxil); Duraclon (Clonidine Injection); Duramorph (Morphine Injection); Dysport (Abobotulinumtoxin A Injection); Ecallantide Injection (Kalbitor); EC-Naprosyn (naproxen); Edetate Calcium Disodium Injection (Calcium Disodium Versenate); Edex (Alprostadil for Injection); Engerix; Edrophonium Injection (Enlon); Eliglustat Tartate; Eloxatin (Oxaliplatin Injection); Emend Injection (Fosaprepitant Dimeglumine Injection); Enalaprilat Injection (Enalaprilat Injection); Enlon (Edrophonium Injection); Enoxaparin Sodium Injection (Lovenox); Eovist (Gadoxetate Disodium Injection); Enbrel (etanercept); Enoxaparin; Epicel; Epinepherine; Epipen; Epipen Jr.; Epratuzumab; Erbitux; Ertapenem Injection (Invanz); Erythropoieten; Essential Amino Acid Injection (Nephramine); Estradiol Cypionate; Estradiol Valerate; Etanercept; Exenatide Injection (Byetta); Evlotra; Fabrazyme (Adalsidase beta); Famotidine Injection; FDG (Fludeoxyglucose F 18 Injection); Feraheme (Ferumoxytol Injection); Feridex I.V. (Ferumoxides Injectable Solution); Fertinex; Ferumoxides Injectable Solution (Feridex I.V.); Ferumoxytol Injection (Feraheme); Flagyl Injection (Metronidazole Injection); Fluarix; Fludara (Fludarabine Phosphate); Fludeoxyglucose F 18 Injection (FDG); Fluorescein Injection (Ak-Fluor); Follistim AQ Cartridge (Follitropin Beta Injection); Follitropin Alfa Injection (Gonal-f RFF); Follitropin Beta Injection (Follistim AQ Cartridge); Folotyn (Pralatrexate Solution for Intravenous Injection); Fondaparinux; Forteo (Teriparatide (rDNA origin) Injection); Fostamatinib; Fosaprepitant Dimeglumine Injection (Emend Injection); Foscarnet Sodium Injection (Foscavir); Foscavir (Foscarnet Sodium Injection); Fosphenytoin Sodium Injection (Cerebyx); Fospropofol Disodium Injection (Lusedra); Fragmin; Fuzeon (enfuvirtide); GA101; Gadobenate Dimeglumine Injection (Multihance); Gadofosveset Trisodium Injection (Ablavar); Gadoteridol Injection Solution (ProHance); Gadoversetamide Injection (OptiMARK); Gadoxetate Disodium Injection (Eovist); Ganirelix (Ganirelix Acetate Injection); Gardasil; GC1008; GDFD; Gemtuzumab Ozogamicin for Injection (Mylotarg); Genotropin; Gentamicin Injection; GENZ-112638; Golimumab Injection (Simponi Injection); Gonal-f RFF (Follitropin Alfa Injection); Granisetron Hydrochloride (Kytril Injection); Gentamicin Sulfate; Glatiramer Acetate; Glucagen; Glucagon; HAE1; Haldol (Haloperidol Injection); Havrix; Hectorol Injection (Doxercalciferol Injection); Hedgehog Pathway Inhibitor; Heparin; Herceptin; hG-CSF; Humalog; Human Growth Hormone; Humatrope; HuMax; Humegon; Humira; Humulin; Ibandronate Sodium Injection (Boniva Injection); Ibuprofen Lysine Injection (NeoProfen); Ibutilide Fumarate Injection (Corvert); Idamycin PFS (Idarubicin Hydrochloride Injection); Idarubicin Hydrochloride Injection (Idamycin PFS); Ilaris (Canakinumab Injection); Imipenem and Cilastatin for Injection (Primaxin I.V.); Imitrex; Incobotulinumtoxin A for Injection (Xeomin); Increlex (Mecasermin [rDNA origin] Injection); Indocin IV (Indomethacin Inj); Indomethacin Inj (Indocin IV); Infanrix; Innohep; Insulin; Insulin Aspart [rDNA origin] Inj (NovoLog); Insulin Glargine [rDNA origin] Injection (Lantus); Insulin Glulisine [rDNA origin] Inj (Apidra); Interferon alfa-2b, Recombinant for Injection (Intron A); Intron A (Interferon alfa-2b, Recombinant for Injection); Invanz (Ertapenem Injection); Invega Sustenna (Paliperidone Palmitate Extended-Release Injectable Suspension); Invirase (saquinavir mesylate); Iobenguane I 123 Injection for Intravenous Use (AdreView); Iopromide Injection (Ultravist); Ioversol Injection (Optiray Injection); Iplex (Mecasermin Rinfabate [rDNA origin] Injection); Iprivask; Irinotecan Hydrochloride (Camptosar Injection); Iron Sucrose Injection (Venofer); Istodax (Romidepsin for Injection); Itraconazole Injection (Sporanox Injection); Jevtana (Cabazitaxel Injection); Jonexa; Kalbitor (Ecallantide Injection); KCL in D5NS (Potassium Chloride in 5% Dextrose and Sodium Chloride Injection); KCL in D5W; KCL in NS; Kenalog 10 Injection (Triamcinolone Acetonide Injectable Suspension); Kepivance (Palifermin); Keppra Injection (Levetiracetam); Keratinocyte; KFG; Kinase Inhibitor; Kineret (Anakinra); Kinlytic (Urokinase Injection); Kinrix; Klonopin (clonazepam); Kytril Injection (Granisetron Hydrochloride); lacosamide Tablet and Injection (Vimpat); Lactated Ringer's; Lanoxin Injection (Digoxin Injection); Lansoprazole for Injection (Prevacid I.V.); Lantus; Leucovorin Calcium (Leucovorin Calcium Injection); Lente (L); Leptin; Levemir; Leukine Sargramostim; Leuprolide Acetate; Levothyroxine; Levetiracetam (Keppra Injection); Lovenox; Levocarnitine Injection (Carnitor Injection); Lexiscan (Regadenoson Injection); Lioresal Intrathecal (Baclofen Injection); Liraglutide [rDNA] Injection (Victoza); Lovenox (Enoxaparin Sodium Injection); Lucentis (Ranibizumab Injection); Lumizyme; Lupron (Leuprolide Acetate Injection); Lusedra (Fospropofol Disodium Injection); Maci; Magnesium Sulfate (Magnesium Sulfate Injection); Mannitol Injection (Mannitol IV); Marcaine (Bupivacaine Hydrochloride and Epinephrine Injection); Maxipime (Cefepime Hydrochloride for Injection); MDP Multidose Kit of Technetium Injection (Technetium Tc99m Medronate Injection); Mecasermin [rDNA origin] Injection (Increlex); Mecasermin Rinfabate [rDNA origin] Injection (Iplex); Melphalan Hcl Injection (Alkeran Injection); Methotrexate; Menactra; Menopur (Menotropins Injection); Menotropins for Injection (Repronex); Methohexital Sodium for Injection (Brevital Sodium); Methyldopate Hydrochloride Injection, Solution (Methyldopate Hcl); Methylene Blue (Methylene Blue Injection); Methylprednisolone Acetate Injectable Suspension (Depo Medrol); MetMab; Metoclopramide Injection (Reglan Injection); Metrodin (Urofollitropin for Injection); Metronidazole Injection (Flagyl Injection); Miacalcin; Midazolam (Midazolam Injection); Mimpara (Cinacalet); Minocin Injection (Minocycline Inj); Minocycline Inj (Minocin Injection); Mipomersen; Mitoxantrone for Injection Concentrate (Novantrone); Morphine Injection (Duramorph); Morphine Sulfate XR Liposome Injection (DepoDur); Morrhuate Sodium (Morrhuate Sodium Injection); Motesanib; Mozobil (Plerixafor Injection); Multihance (Gadobenate Dimegluminc Injection); Multiple Electrolytes and Dextrose Injection; Multiple Electrolytes Injection; Mylotarg (Gemtuzumab Ozogamicin for Injection); Myozyme (Alglucosidase alfa); Nafcillin Injection (Nafcillin Sodium); Nafcillin Sodium (Nafcillin Injection); Naltrexone XR Inj (Vivitrol); Naprosyn (naproxen); NeoProfen (Ibuprofen Lysine Injection); Nandrol Decanoate; Neostigmine Methylsulfate (Neostigmine Methylsulfate Injection); NEO-GAA; NeoTect (Technetium Tc 99m Depreotide Injection); Nephramine (Essential Amino Acid Injection); Neulasta (pegfilgrastim); Neupogen (Filgrastim); Novolin; Novolog; NeoRecormon; Neutrexin (Trimetrexate Glucuronate Inj); NPH (N); Nexterone (Amiodarone HCl Injection); Norditropin (Somatropin Injection); Normal Saline (Sodium Chloride Injection); Novantrone (Mitoxantrone for Injection Concentrate); Novolin 70/30 Innolet (70% NPH, Human Insulin Isophane Suspension and 30% Regular, Human Insulin Injection); NovoLog (Insulin Aspart [rDNA origin] Inj); Nplatc (romiplostim); Nutropin (Somatropin (rDNA origin) for Inj); Nutropin AQ; Nutropin Depot (Somatropin (rDNA origin) for Ink Octreotide Acetate Injection (Sandostatin LAR); Ocrelizumab; Ofatumumab Injection (Arzerra); Olanzapine Extended Release Injectable Suspension (Zyprexa Relprevv); Omnitarg; Omnitrope (Somatropin [rDNA origin] Injection); Ondansetron Hydrochloride Injection (Zofran Injection); OptiMARK (Gadoversetamide Injection); Optiray Injection (Ioversol Injection); Orencia; Osmitrol Injection in Aviva (Mannitol Injection in Aviva Plastic Vessel); Osmitrol Injection in Viaflex (Mannitol Injection in Viaflex Plastic Vessel); Osteoprotegrin; Ovidrel (Choriogonadotropin Alfa Injection); Oxacillin (Oxacillin for Injection); Oxaliplatin Injection (Eloxatin); Oxytocin Injection (Pitocin); Paliperidone Palmitate Extended-Release Injectable Suspension (Invega Sustenna); Pamidronate Disodium Injection (Pamidronate Disodium Injection); Panitumumab Injection for Intravenous Use (Vectibix); Papaverine Hydrochloride Injection (Papaverine Injection); Papaverine Injection (Papaverine Hydrochloride Injection); Parathyroid Hormone; Paricalcitol Injection Fliptop Vial (Zemplar Injection); PARP Inhibitor; Pediarix; PEGIntron; Peginterferon; Pegfilgrastim; Penicillin G Benzathine and Penicillin G Procaine; Pentetate Calcium Trisodium Inj (Ca-DTPA); Pentetate Zinc Trisodium Injection (Zn-DTPA); Pepcid Injection (Famotidine Injection); Pergonal; Pertuzumab; Phentolamine Mesylate (Phentolamine Mesylate for Injection); Physostigmine Salicylate (Physostigmine Salicylate (injection)); Physostigmine Salicylate (injection) (Physostigmine Salicylate); Piperacillin and Tazobactam Injection (Zosyn); Pitocin (Oxytocin Injection); Plasma-Lyte 148 (Multiple Electrolytes Inj); Plasma-Lyte 56 and Dextrose (Multiple Electrolytes and Dextrose Injection in Viaflex Plastic Vessel); PlasmaLyte; Plerixafor Injection (Mozobil); Polidocanol Injection (Asclera); Potassium Chloride; Pralatrexate Solution for Intravenous Injection (Folotyn); Pramlintide Acetate Injection (Symlin); Premarin Injection (Conjugated Estrogens for Injection); Prep kit for Technetium Tc99 Sestamibi for Injection (Cardiolite); Prevacid I.V. (Lansoprazole for Injection); Primaxin I.V. (Imipenem and Cilastatin for Injection); Prochymal; Procrit; Progesterone; ProHance (Gadoteridol Injection Solution); Prolia (Denosumab Injection); Promethazine HCl Injection (Promethazine Hydrochloride Injection); Propranolol Hydrochloride Injection (Propranolol Hydrochloride Injection); Quinidine Gluconate Injection (Quinidine Injection); Quinidine Injection (Quinidine Gluconate Injection); R-Gene 10 (Arginine Hydrochloride Injection); Ranibizumab Injection (Lucentis); Ranitidine Hydrochloride Injection (Zantac Injection); Raptiva; Reclast (Zoledronic Acid Injection); Recombivarix HB; Regadenoson Injection (Lexiscan); Reglan Injection (Metoclopramide Injection); Remicade; Renagel; Renvela (Sevelamer Carbonate); Repronex (Menotropins for Injection); Retrovir IV (Zidovudine Injection); rhApo2L/TRAIL; Ringer's and 5% Dextrose Injection (Ringers in Dextrose); Ringer's Injection (Ringers Injection); Rituxan; Rituximab; Rocephin (ceftriaxone); Rocuronium Bromide Injection (Zemuron); Roferon-A (interferon alfa-2a); Romazicon (flumazenil); Romidepsin for Injection (Islodax); Saizen (Somatropin Injection); Sandostatin LAR (Octreotide Acetate Injection); Sclerostin Ab; Sensipar (cinacalcet); Sensorcaine (Bupivacaine HCl Injections); Septocaine (Articane HCl and Epinephrine Injection); Serostim LQ (Somatropin (rDNA origin) Injection); Simponi Injection (Golimumab Injection); Sodium Acetate (Sodium Acetate Injection); Sodium Bicarbonate (Sodium Bicarbonate 5% Injection); Sodium Lactate (Sodium Lactate Injection in AVIVA); Sodium Phenylacetate and Sodium Benzoate Injection (Ammonul); Somatropin (rDNA origin) for Inj (Nutropin); Sporanox Injection (Itraconazole Injection); Stelara Injection (Ustekinumab); Stemgen; Sufenta (Sufentanil Citrate Injection); Sufentanil Citrate Injection (Sufenta); Sumavel; Sumatriptan Injection (Alsuma); Symlin; Symlin Pen; Systemic Hedgehog Antagonist; Synvisc-One (Hylan G-F 20 Single Intra-articular Injection); Tarceva; Taxotere (Docetaxel for Injection); Technetium Tc 99m; Telavancin for Injection (Vibativ); Temsirolimus Injection (Torisel); Tenormin I.V. Injection (Atenolol Inj); Teriparatide (rDNA origin) Injection (Forteo); Testosterone Cypionate; Testosterone Enanthate; Testosterone Propionate; Tev-Tropin (Somatropin, rDNA Origin, for Injection); tgAAC94; Thallous Chloride; Theophylline; Thiotepa (Thiotcpa Injection); Thymoglobulin (Anti-Thymocyte Globulin (Rabbit); Thyrogen (Thyrotropin Alfa for Injection); Ticarcillin Disodium and Clavulanate Potassium Galaxy (Timentin Injection); Tigan Injection (Trimethobenzamide Hydrochloride Injectable); Timentin Injection (Ticarcillin Disodium and Clavulanate Potassium Galaxy); TNKase; Tobramycin Injection (Tobramycin Injection); Tocilizumab Injection (Actemra); Torisel (Temsirolimus Injection); Totect (Dexrazoxane for Injection, Intravenous Infusion Only); Trastuzumab-DM1; Travasol (Amino Acids (Injection)); Treanda (Bendamustine Hydrochloride Injection); Trelstar (Triptorelin Pamoate for Injectable Suspension); Triamcinolone Acetonide; Triamcinolone Diacetate; Triamcinolone Hexacetonide Injectable Suspension (Aristospan Injection 20 mg); Triesence (Triamcinolone Acetonide Injectable Suspension); Trimethobenzamide Hydrochloride Injectable (Tigan Injection); Trimetrexate Glucuronate Inj (Neutrexin); Triptorelin Pamoate for Injectable Suspension (Trelstar); Twinject; Trivaris (Triamcinolone Acetonide Injectable Suspension); Trisenox (Arsenic Trioxide Injection); Twinrix; Typhoid Vi; Ultravist (Iopromide Injection); Urofollitropin for Injection (Metrodin); Urokinase Injection (Kinlytic); Ustekinumab (Stelara Injection); Ultralente (U); Valium (diazepam); Valproate Sodium Injection (Depacon); Valtropin (Somatropin Injection); Vancomycin Hydrochloride (Vancomycin Hydrochloride Injection); Vancomycin Hydrochloride Injection (Vancomycin Hydrochloride); Vaprisol (Conivaptan Hcl Injection); VAQTA; Vasovist (Gadofosveset Trisodium Injection for Intravenous Use); Vectibix (Panitumumab Injection for Intravenous Use); Venofer (Iron Sucrose Injection); Verteporfin Inj (Visudyne); Vibativ (Telavancin for Injection); Victoza (Liraglutide [rDNA] Injection); Vimpat (lacosamide Tablet and Injection); Vinblastine Sulfate (Vinblastine Sulfate Injection); Vincasar PFS (Vincristine Sulfate Injection); Victoza; Vincristine Sulfate (Vincristine Sulfate Injection); Visudyne (Verteporfin Inj); Vitamin B-12; Vivitrol (Naltrexone XR Inj); Voluven (Hydroxyethyl Starch in Sodium Chloride Injection); Xeloda; Xenical (orlistat); Xeomin (Incobotulinumtoxin A for Injection); Xolair; Zantac Injection (Ranitidine Hydrochloride Injection); Zemplar Injection (Paricalcitol Injection Fliptop Vial); Zemuron (Rocuronium Bromide Injection); Zenapax (daclizumab); Zevalin; Zidovudine Injection (Retrovir IV); Zithromax Injection (Azithromycin); Zn-DTPA (Pentetate Zinc Trisodium Injection); Zofran Injection (Ondansetron Hydrochloride Injection); Zingo; Zoledronic Acid for Inj (Zometa); Zoledronic Acid Injection (Reclast); Zometa (Zoledronic Acid for Inj); Zosyn (Piperacillin and Tazobactam Injection); and Zyprexa Relprevv (Olanzapine Extended Release Injectable Suspension);
LIQUID DRUGS (NON-INJECTABLE), which optionally include:
Abilify; AccuNeb (Albuterol Sulfate Inhalation Solution); Actidose Aqua (Activated Charcoal Suspension); Activated Charcoal Suspension (Actidose Aqua); Advair; Agenerase Oral Solution (Amprenavir Oral Solution); Akten (Lidocaine Hydrochloride Ophthalmic Gel); Alamast (Pemirolast Potassium Ophthalmic Solution); Albumin (Human) 5% Solution (Buminate 5%); Albuterol Sulfate Inhalation Solution; Alinia; Alocril; Alphagan; Alrex; Alvesco; Amprenavir Oral Solution; Analpram-HC; Arformoterol Tartrate Inhalation Solution (Brovana); Aristospan Injection 20 mg (Triamcinolone Hexacetonide Injectable Suspension); Asacol; Asmanex; Astepro; Astepro (Azelastine Hydrochloride Nasal Spray); Atrovent Nasal Spray (Ipratropium Bromide Nasal Spray); Atrovent Nasal Spray 0.06; Augmentin ES-600; Azasite (Azithromycin Ophthalmic Solution); Azelaic Acid (Finacca Gel); Azelastine Hydrochloride Nasal Spray (Astepro); Azelex (Azelaic Acid Cream); Azopt (Brinzolamide Ophthalmic Suspension); Bacteriostatic Saline; Balanced Salt; Bepotastine; Bactroban Nasal; Bactroban; Beclovent; Benzac W; Betimol; Betoptic S; Bepreve; Bimatoprost Ophthalmic Solution; Bleph 10 (Sulfacetamide Sodium Ophthalmic Solution 10%); Brinzolamide Ophthalmic Suspension (Azopt); Bromfenac Ophthalmic Solution (Xibrom); Bromhist; Brovana (Arformoterol Tartrate Inhalation Solution); Budesonide Inhalation Suspension (Pulmicort Respules); Cambia (Diclofenac Potassium for Oral Solution); Capex; Carac; Carboxine-PSE; Carnitor; Cayston (Aztreonam for Inhalation Solution); Cellcept; Centany; Cerumenex; Ciloxan Ophthalmic Solution (Ciprofloxacin HCL Ophthalmic Solution); Ciprodex; Ciprofloxacin HCL Ophthalmic Solution (Ciloxan Ophthalmic Solution); Clemastine Fumarate Syrup (Clemastine Fumarate Syrup); CoLyte (PEG Electrolytes Solution); Combiven; Comtan; Condylox; Cordran; Cortisporin Ophthalmic Suspension; Cortisporin Otic Suspension; Cromolyn Sodium Inhalation Solution (Intal Nebulizer Solution); Cromolyn Sodium Ophthalmic Solution (Opticrom); Crystalline Amino Acid Solution with Electrolytes (Aminosyn Electrolytes); Cutivate; Cuvposa (Glycopyrrolate Oral Solution); Cyanocobalamin (CaloMist Nasal Spray); Cyclosporine Oral Solution (Gengraf Oral Solution); Cyclogyl; Cysview (Hexaminolevulinate Hydrochloride Intravesical Solution); DermOtic Oil (Fluocinolone Acetonide Oil Ear Drops); Desmopressin Acetate Nasal Spray; DDAVP; Derma-Smoothe/FS; Dexamethasone Intensol; Dianeal Low Calcium; Dianeal PD; Diclofenac Potassium for Oral Solution (Cambia); Didanosine Pediatric Powder for Oral Solution (Videx); Differin; Dilantin 125 (Phenytoin Oral Suspension); Ditropan; Dorzolamide Hydrochloride Ophthalmic Solution (Trusopt); Dorzolamide Hydrochloride-Timolol Maleate Ophthalmic Solution (Cosopt); Dovonex Scalp (Calcipotriene Solution); Doxycycline Calcium Oral Suspension (Vibramycin Oral); Efudex; Elaprase (Idursulfase Solution); Elestat (Epinastine HCl Ophthalmic Solution); Elocon; Epinastine HCl Ophthalmic Solution (Elestat); Epivir HBV; Epogen (Epoetin alfa); Erythromycin Topical Solution 1.5% (Staticin); Ethiodol (Ethiodized Oil); Ethosuximide Oral Solution (Zarontin Oral Solution); Eurax; Extraneal (Icodextrin Peritoneal Dialysis Solution); Felbatol; Feridex I.V. (Ferumoxides Injectable Solution); Flovent; Floxin Otic (Ofloxacin Otic Solution); Flo-Pred (Prednisolone Acetate Oral Suspension); Fluoroplex; Flunisolide Nasal Solution (Flunisolide Nasal Spray 0.025%); Fluorometholone Ophthalmic Suspension (FML); Flurbiprofen Sodium Ophthalmic Solution (Ocufen); FML; Foradil; Formoterol Fumarate Inhalation Solution (Perforomist); Fosamax; Furadantin (Nitrofurantoin Oral Suspension); Furoxone; Gammagard Liquid (Immune Globulin Intravenous (Human) 10%); Gantrisin (Acetyl Sulfisoxazole Pediatric Suspension); Gatifloxacin Ophthalmic Solution (Zymar); Gengraf Oral Solution (Cyclosporine Oral Solution); Glycopyrrolate Oral Solution (Cuvposa); Halcinonide Topical Solution (Halog Solution); Halog Solution (Halcinonide Topical Solution); HEP-LOCK U/P (Preservative-Free Heparin Lock Flush Solution); Heparin Lock Flush Solution (Hepflush 10); Hexaminolevulinate Hydrochloride Intravesical Solution (Cysview); Hydrocodone Bitartrate and Acetaminophen Oral Solution (Lortab Elixir); Hydroquinone 3% Topical Solution (Melquin-3 Topical Solution); IAP Antagonist; Isopto; Ipratropium Bromide Nasal Spray (Atrovent Nasal Spray); Itraconazole Oral Solution (Sporanox Oral Solution); Ketorolac Tromethamine Ophthalmic Solution (Acular LS); Kaletra; Lanoxin; Lexiva; Leuprolide Acetate for Depot Suspension (Lupron Depot 11.25 mg); Levobetaxolol Hydrochloride Ophthalmic Suspension (Betaxon); Levocarnitine Tablets, Oral Solution, Sugar-Free (Carnitor); Levofloxacin Ophthalmic Solution 0.5% (Quixin); Lidocaine HCl Sterile Solution (Xylocaine MPF Sterile Solution); Lok Pak (Heparin Lock Flush Solution); Lorazepam Intensol; Lortab Elixir (Hydrocodone Bitartrate and Acetaminophen Oral Solution); Lotemax (Loteprednol Etabonate Ophthalmic Suspension); Loteprednol Etabonate Ophthalmic Suspension (Alrex); Low Calcium Peritoneal Dialysis Solutions (Dianeal Low Calcium); Lumigan (Bimatoprost Ophthalmic Solution 0.03% for Glaucoma); Lupron Depot 11.25 mg (Leuprolide Acetate for Depot Suspension); Megestrol Acetate Oral Suspension (Megestrol Acetate Oral Suspension); MEK Inhibitor; Mepron; Mesnex; Mcstinon; Mesalamine Rectal Suspension Enema (Rowasa); Melquin-3 Topical Solution (Hydroquinone 3% Topical Solution); MetMab; Methyldopate Hcl (Methyldopate Hydrochloride Injection, Solution); Methylin Oral Solution (Methylphenidate HCl Oral Solution 5 mg/5 mL and 10 mg/5 mL); Methylprednisolone Acetate Injectable Suspension (Depo Medrol); Methylphenidate HCl Oral Solution 5 mg/5 mL and 10 mg/5 mL (Methylin Oral Solution); Methylprednisolone sodium succinate (Solu Medrol); Metipranolol Ophthalmic Solution (Optipranolol); Migranal; Miochol-E (Acetylcholine Chloride Intraocular Solution); Micro-K for Liquid Suspension (Potassium Chloride Extended Release Formulation for Liquid Suspension); Minocin (Minocycline Hydrochloride Oral Suspension); Nasacort; Neomycin and Polymyxin B Sulfates and Hydrocortisone; Nepafenac Ophthalmic Suspension (Nevanac); Nevanac (Nepafenac Ophthalmic Suspension); Nitrofurantoin Oral Suspension (Furadantin); Noxafil (Posaconazole Oral Suspension); Nystatin (oral) (Nystatin Oral Suspension); Nystatin Oral Suspension (Nystatin (oral)); Ocufen (Flurbiprofen Sodium Ophthalmic Solution); Ofloxacin Ophthalmic Solution (Ofloxacin Ophthalmic Solution); Ofloxacin Otic Solution (Floxin Otic); Olopatadine Hydrochloride Ophthalmic Solution (Pataday); Opticrom (Cromolyn Sodium Ophthalmic Solution); Optipranolol (Metipranolol Ophthalmic Solution); Patanol; Pediapred; PerioGard; Phenytoin Oral Suspension (Dilantin 125); Phisohex; Posaconazole Oral Suspension (Noxafil); Potassium Chloride Extended Release Formulation for Liquid Suspension (Micro-K for Liquid Suspension); Pataday (Olopatadine Hydrochloride Ophthalmic Solution); Patanase Nasal Spray (Olopatadine Hydrochloride Nasal Spray); PEG Electrolytes Solution (CoLyte); Pemirolast Potassium Ophthalmic Solution (Alamast); Penlac (Ciclopirox Topical Solution); PENNSAID (Diclofenac Sodium Topical Solution); Perforomist (Formoterol Fumarate Inhalation Solution); Peritoneal Dialysis Solution; Phenylephrine Hydrochloride Ophthalmic Solution (Neo-Synephrine); Phospholine Iodide (Echothiophate Iodide for Ophthalmic Solution); Podofilox (Podofilox Topical Solution); Pred Forte (Prednisolone Acetate Ophthalmic Suspension); Pralatrexate Solution for Intravenous Injection (Folotyn); Pred Mild; Prednisone Intensol; Prednisolone Acetate Ophthalmic Suspension (Pred Forte); Prevacid; PrismaSol Solution (Sterile Hemofiltration Hemodiafiltration Solution); ProAir; Proglycem; ProHance (Gadoteridol Injection Solution); Proparacaine Hydrochloride Ophthalmic Solution (Alcaine); Propine; Pulmicort; Pulmozyme; Quixin (Levofloxacin Ophthalmic Solution 0.5%); QVAR; Rapamune; Rebetol; Relacon-HC; Rotarix (Rotavirus Vaccine, Live, Oral Suspension); Rotavirus Vaccine, Live, Oral Suspension (Rotarix); Rowasa (Mesalamine Rectal Suspension Enema); Sabril (Vigabatrin Oral Solution); Sacrosidase Oral Solution (Sucraid); Sandimmune; Sepra; Serevent Diskus; Solu Cortef (Hydrocortisone Sodium Succinate); Solu Medrol (Methylprednisolone sodium succinate); Spiriva; Sporanox Oral Solution (Itraconazole Oral Solution); Staticin (Erythromycin Topical Solution 1.5%); Stalevo; Starlix; Sterile Hemofiltration Hemodiafiltration Solution (PrismaSol Solution); Stimate; Sucralfate (Carafate Suspension); Sulfacetamide Sodium Ophthalmic Solution 10% (Bleph 10); Synarel Nasal Solution (Nafarelin Acetate Nasal Solution for Endometriosis); Taclonex Scalp (Calcipotriene and Betamethasone Dipropionate Topical Suspension); Tamiflu; Tobi; TobraDex; Tobradex ST (Tobramycin/Dexamethasone Ophthalmic Suspension 0.3%/0.05%); Tobramycin/Dexamethasone Ophthalmic Suspension 0.3%/0.05% (Tobradex ST); Timolol; Timoptic; Travatan Z; Treprostinil Inhalation Solution (Tyvaso); Trusopt (Dorzolamide Hydrochloride Ophthalmic Solution); Tyvaso (Treprostinil Inhalation Solution); Ventolin; Vfend; Vibramycin Oral (Doxycycline Calcium Oral Suspension); Videx (Didanosine Pediatric Powder for Oral Solution); Vigabatrin Oral Solution (Sabril); Viokase; Viracept; Viramune; Vitamin K1 (Fluid Colloidal Solution of Vitamin K1); Voltaren Ophthalmic (Diclofenac Sodium Ophthalmic Solution); Zarontin Oral Solution (Ethosuximide Oral Solution); Ziagen; Zyvox; Zymar (Gatifloxacin Ophthalmic Solution); and Zymaxid (Gatifloxacin Ophthalmic Solution);
DRUG CLASSES, which optionally include:
5-alpha-reductase inhibitors; 5-aminosalicylates; 5HT3 receptor antagonists; adamantane antivirals; adrenal cortical steroids; adrenal corticosteroid inhibitors; adrenergic bronchodilators; agents for hypertensive emergencies; agents for pulmonary hypertension; aldosterone receptor antagonists; alkylating agents; alpha-adrenoreceptor antagonists; alpha-glucosidase inhibitors; alternative medicines; amebicides; aminoglycosides; aminopenicillins; aminosalicylates; amylin analogs; Analgesic Combinations; Analgesics; androgens and anabolic steroids; angiotensin converting enzyme inhibitors; angiotensin II inhibitors; anorectal preparations; anorexiants; antacids; anthelmintics; anti-angiogenic ophthalmic agents; anti-CTLA-4 monoclonal antibodies; anti-infectives; antiadrenergic agents, centrally acting; antiadrenergic agents, peripherally acting; antiandrogens; anti anginal agents; anti arrhythmic agents; anti asthmatic combinations; antibiotics/antineoplastics; anticholinergic antiemetics; anticholinergic antiparkinson agents; anticholinergic bronchodilators; anticholinergic chronotropic agents; anticholinergics/antispasmodics; anticoagulants; anticonvulsants; antidepressants; antidiabetic agents; antidiabetic combinations; antidian-heals; antidiuretic hormones; antidotes; antiemetic/antivertigo agents; antifungals; antigonadotropic agents; antigout agents; antihistamines; antihyperlipidemic agents; antihyperlipidemic combinations; antihypertensive combinations; antihyperuricemic agents; antimalarial agents; antimalarial combinations; antimalarial quinolines; antimetabolites; antimigraine agents; antineoplastic detoxifying agents; antineoplastic interferons; antineoplastic monoclonal antibodies; antineoplastics; antiparkinson agents; antiplatelet agents; antipseudomonal penicillins; antipsoriatics; antipsychotics; antirheumatics; antiseptic and germicides; antithyroid agents; antitoxins and antivenins; antituberculosis agents; antituberculosis combinations; antitussives; antiviral agents; antiviral combinations; antiviral interferons; anxiolytics, sedatives, and hypnotics; aromatase inhibitors; atypical antipsychotics; azole antifungals; bacterial vaccines; barbiturate anticonvulsants; barbiturates; BCR-ABL tyrosine kinase inhibitors; benzodiazepine anticonvulsants; benzodiazepines; beta-adrenergic blocking agents; beta-lactamase inhibitors; bile acid sequestrants; biologicals; bisphosphonates; bone resorption inhibitors; bronchodilator combinations; bronchodilators; calcitonin; calcium channel blocking agents; carbamate anticonvulsants; carbapenems; carbonic anhydrase inhibitor anticonvulsants; carbonic anhydrase inhibitors; cardiac stressing agents; cardioselective beta blockers; cardiovascular agents; catecholamines; CD20 monoclonal antibodies; CD33 monoclonal antibodies; CD52 monoclonal antibodies; central nervous system agents; cephalosporins; cerumenolytics; chelating agents; chemokine receptor antagonist; chloride channel activators; cholesterol absorption inhibitors; cholinergic agonists; cholinergic muscle stimulants; cholinesterase inhibitors; CNS stimulants; coagulation modifiers; colony stimulating factors; contraceptives; corticotropin; coumarins and indandiones; cox-2 inhibitors; decongestants; dermatological agents; diagnostic radiopharmaceuticals; dibenzazepine anticonvulsants; digestive enzymes; dipeptidyl peptidase 4 inhibitors; diuretics; dopaminergic antiparkinsonism agents; drugs used in alcohol dependence; echinocandins; EGFR inhibitors; estrogen receptor antagonists; estrogens; expectorants; factor Xa inhibitors; fatty acid derivative anticonvulsants; fibric acid derivatives; first generation cephalosporins; fourth generation cephalosporins; functional bowel disorder agents; gallstone solubilizing agents; gamma-aminobutyric acid analogs; gamma-aminobutyric acid reuptake inhibitors; gamma-aminobutyric acid transaminase inhibitors; gastrointestinal agents; general anesthetics; genitourinary tract agents; GI stimulants; glucocorticoids; glucose elevating agents; glycopeptide antibiotics; glycoprotein platelet inhibitors; glycylcyclines; gonadotropin releasing hormones; gonadotropin-releasing hormone antagonists; gonadotropins; group I antiarrhythmics; group II antiarrhythmics; group III antiarrhythmics; group IV antiarrhythmics; group V antiarrhythmics; growth hormone receptor blockers; growth hormones; H. pylori eradication agents; H2 antagonists; hematopoietic stem cell mobilizer; heparin antagonists; heparins; HER2 inhibitors; herbal products; histone deacetylase inhibitors; hormone replacement therapy; hormones; hormones/antineoplastics; hydantoin anticonvulsants; illicit (street) drugs; immune globulins; immunologic agents; immunosuppressive agents; impotence agents; in vivo diagnostic biologicals; incretin mimetics; inhaled anti-infectives; inhaled corticosteroids; inotropic agents; insulin; insulin-like growth factor; integrase strand transfer inhibitor; interferons; intravenous nutritional products; iodinated contrast media; ionic iodinated contrast media; iron products; ketolides; laxatives; leprostatics; leukotriene modifiers; lincomycin derivatives; lipoglycopeptides; local injectable anesthetics; loop diuretics; lung surfactants; lymphatic staining agents; lysosomal enzymes; macrolide derivatives; macrolides; magnetic resonance imaging contrast media; mast cell stabilizers; medical gas; meglitinides; metabolic agents; methylxanthines; mineralocorticoids; minerals and electrolytes; miscellaneous agents; miscellaneous analgesics; miscellaneous antibiotics; miscellaneous anticonvulsants; miscellaneous antidepressants; miscellaneous antidiabetic agents; miscellaneous antiemetics; miscellaneous antifungals; miscellaneous antihyperlipidemic agents; miscellaneous antimalarials; miscellaneous antineoplastics; miscellaneous antiparkinson agents; miscellaneous antipsychotic agents; miscellaneous antituberculosis agents; miscellaneous antivirals; miscellaneous anxiolytics, sedatives and hypnotics; miscellaneous biologicals; miscellaneous bone resorption inhibitors; miscellaneous cardiovascular agents; miscellaneous central nervous system agents; miscellaneous coagulation modifiers; miscellaneous diuretics; miscellaneous genitourinary tract agents; miscellaneous GI agents; miscellaneous hormones; miscellaneous metabolic agents; miscellaneous ophthalmic agents; miscellaneous otic agents; miscellaneous respiratory agents; miscellaneous sex hormones; miscellaneous topical agents; miscellaneous uncategorized agents; miscellaneous vaginal agents; mitotic inhibitors; monoamine oxidase inhibitors; monoclonal antibodies; mouth and throat products; mTOR inhibitors; mTOR kinase inhibitors; mucolytics; multikinase inhibitors; muscle relaxants; mydriatics; narcotic analgesic combinations; narcotic analgesics; nasal anti-infectives; nasal antihistamines and decongestants; nasal lubricants and irrigations; nasal preparations; nasal steroids; natural penicillins; neuraminidase inhibitors; neuromuscular blocking agents; next generation cephalosporins; nicotinic acid derivatives; nitrates; NNRTIs; non-cardioselective beta blockers; non-iodinated contrast media; non-ionic iodinated contrast media; non-sulfonylureas; nonsteroidal anti-inflammatory agents; norepinephrine reuptake inhibitors; norepinephrine-dopamine reuptake inhibitors; nucleoside reverse transcriptase inhibitors (NRTIs); nutraceutical products; nutritional products; ophthalmic anesthetics; ophthalmic anti-infectives; ophthalmic anti-inflammatory agents; ophthalmic antihistamines and decongestants; ophthalmic diagnostic agents; ophthalmic glaucoma agents; ophthalmic lubricants and irrigations; ophthalmic preparations; ophthalmic steroids; ophthalmic steroids with anti-infectives; ophthalmic surgical agents; oral nutritional supplements; otic anesthetics; otic anti-infectives; otic preparations; otic steroids; otic steroids with anti-infectives; oxazolidincdione anticonvulsants; parathyroid hormone and analogs; penicillinase resistant penicillins; penicillins; peripheral opioid receptor antagonists; peripheral vasodilators; peripherally acting antiobesity agents; phenothiazine antiemetics; phenothiazine antipsychotics; phenylpiperazine antidepressants; plasma expanders; platelet aggregation inhibitors; platelet-stimulating agents; polyenes; potassium-sparing diuretics; probiotics; progesterone receptor modulators; progestins; prolactin inhibitors; prostaglandin D2 antagonists; protease inhibitors; proton pump inhibitors; psoralens; psychotherapeutic agents; psychotherapeutic combinations; purine nucleosides; pyrrolidine anticonvulsants; quinolones; radiocontrast agents; radiologic adjuncts; radiologic agents; radiologic conjugating agents; radiopharmaceuticals; RANK ligand inhibitors; recombinant human erythropoietins; renin inhibitors; respiratory agents; respiratory inhalant products; rifamycin derivatives; salicylates; sclerosing agents; second generation cephalosporins; selective estrogen receptor modulators; selective serotonin reuptake inhibitors; serotonin-norepinephrine reuptake inhibitors; serotoninergic neuroenteric modulators; sex hormone combinations; sex hormones; skeletal muscle relaxant combinations; skeletal muscle relaxants; smoking cessation agents; somatostatin and somatostatin analogs; spermicides; statins; sterile irrigating solutions; Streptomyces derivatives; succinimide anticonvulsants; sulfonamides; sulfonylureas; synthetic ovulation stimulants; tetracyclic antidepressants; tetracyclines; therapeutic radiopharmaceuticals; thiazide diuretics; thiazolidinediones; thioxanthenes; third generation cephalosporins; thrombin inhibitors; thrombolytics; thyroid drugs; tocolytic agents; topical acne agents; topical agents; topical anesthetics; topical anti-infectives; topical antibiotics; topical antifungals; topical antihistamines; topical antipsoriatics; topical antivirals; topical astringents; topical debriding agents; topical depigmenting agents; topical emollients; topical keratolytics; topical steroids; topical steroids with anti-infectives; toxoids; triazine anticonvulsants; tricyclic antidepressants; trifunctional monoclonal antibodies; tumor necrosis factor (TNF) inhibitors; tyrosine kinase inhibitors; ultrasound contrast media; upper respiratory combinations; urea anticonvulsants; urinary anti-infectives; urinary antispasmodics; urinary pH modifiers; uterotonic agents; vaccine; vaccine combinations; vaginal anti-infectives; vaginal preparations; vasodilators; vasopressin antagonists; vasopressors; VEGF/VEGFR inhibitors; viral vaccines; viscosupplementation agents; vitamin and mineral combinations; and vitamins;
and
DIAGNOSTIC TESTS, which optionally include:
17-Hydroxyprogesterone; ACE (Angiotensin I converting enzyme); Acetaminophen; Acid phosphatase; ACTH; Activated clotting time; Activated protein C resistance; Adrenocorticotropic hormone (ACTH); Alanine aminotransferase (ALT); Albumin; Aldolase; Aldosterone; Alkaline phosphatase; Alkaline phosphatase (ALP); Alpha 1-antitrypsin; Alpha-fetoprotein; Alpha-fetoprotien; Ammonia levels; Amylase; ANA (antinuclear antibodies); ANA (antinuclear antibodies); Angiotensin-converting enzyme (ACE); Anion gap; Anticardiolipin antibody; Anticardiolipin antibodies (ACA); Anti-centromere antibody; Antidiuretic hormone; Anti-DNA; Anti-Dnase-B; Anti-Gliadin antibody; Anti-glomerular basement membrane antibody; Anti-HBc (Hepatitis B core antibodies; Anti-HBs (Hepatitis B surface antibody; Antiphospholipid antibody; Anti-RNA polymerase; Anti-Smith (Sm) antibodies; Anti-Smooth Muscle antibody; Antistreptolysin O (ASO); Antithrombin III; Anti-Xa activity; Anti-Xa assay; Apolipoproteins; Arsenic; Aspartate aminotransferase (AST); B12; Basophil; Beta-2-Microglobulin; Beta-hydroxybutyrate; B-HCG; Bilirubin; Bilirubin, direct; Bilirubin, indirect; Bilirubin, total; Bleeding time; Blood gases (arterial); Blood urea nitrogen (BUN); BUN; BUN (blood urea nitrogen); CA 125; CA 15-3; CA 19-9; Calcitonin; Calcium; Calcium (ionized); Carbon monoxide (CO); Carcinoembryonic antigen (CEA); CBC; CEA; CEA (carcinoembryonic antigen); Ceruloplasmin; CH50Chloride; Cholesterol; Cholesterol, HDL; Clot lysis time; Clot retraction time; CMP; CO2; Cold agglutinins; Complement C3; Copper; Corticotrophin releasing hormone (CRH) stimulation test; Cortisol; Cortrosyn stimulation test; C-peptide; CPK (Total); CPK-MB; C-reactive protein; Creatinine; Creatinine kinase (CK); Cryoglobulins; DAT (Direct antiglobulin test); D-Dimer; Dexamethasone suppression test; DHEA-S; Dilute Russell viper venom; Elliptocytes; Eosinophil; Erythrocyte sedimentation rate (ESR); Estradiol; Estriol; Ethanol; Ethylene glycol; Euglobulin lysis; Factor V Leiden; Factor VIII inhibitor; Factor VIII level; Ferritin; Fibrin split products; Fibrinogen; Folate; Folate (serum; Fractional excretion of sodium (FENA); FSH (follicle stimulating factor); FTA-ABS; Gamma glutamyl transferase (GGT); Gastrin; GGTP (Gamma glutamyl transferase); Glucose; Growth hormone; Haptoglobin; HBeAg (Hepatitis Be antigen); HBs-Ag (Hepatitis B surface antigen); Helicobacter pylori; Hematocrit; Hematocrit (HCT); Hemoglobin; Hemoglobin A1C; Hemoglobin electrophoresis; Hepatitis A antibodies; Hepatitis C antibodies; IAT (Indirect antiglobulin test); Immunofixation (IFE); Iron; Lactate dehydrogenase (LDH); Lactic acid (lactate); LDH; LH (Leutinizing hormone; Lipase; Lupus anticoagulant; Lymphocyte; Magnesium; MCH (mean corpuscular hemoglobin; MCHC (mean corpuscular hemoglobin concentration); MCV (mean corpuscular volume); Methylmalonate; Monocyte; MPV (mean platelet volume); Myoglobin; Neutrophil; Parathyroid hormone (PTH); Phosphorus; Platelets (plt); Potassium; Prealbumin; Prolactin; Prostate specific antigen (PSA); Protein C; Protein S; PSA (prostate specific antigen); PT (Prothrombin lime); PTT (Partial thromboplastin time); RDW (red cell distribution width); Renin; Rennin; Reticulocyte count; reticulocytes; Rheumatoid factor (RF); Sed Rate; Serum glutamic-pyruvic transaminase (SGPT; Serum protein electrophoresis (SPEP); Sodium; T3-resin uptake (T3RU); T4, Free; Thrombin time; Thyroid stimulating hormone (TSH); Thyroxine (T4); Total iron binding capacity (TIBC); Total protein; Transferrin; Transferrin saturation; Triglyceride (TG); Troponin; Uric acid; Vitamin B12; White blood cells (WBC); and Widal test.

29. A method of making the vial of any previous claim comprising injection molding the vial.

30. The method of claim 29 comprising providing a mold cavity in the shape of the outer profile of the vial, disposing a core pin within the mold cavity to form the shape of the inside of the product compartment, the core pin preferably having a draft angle so as to make the internal sidewall substantially conical or frustoconical in shape along a substantial length thereof.

31. The method of claim 30, wherein the core pin comprises a slight annular bump used to form a small annular undercut in the internal surface of the vial internal to the neck or rim, optionally wherein the undercut has a radius of from 0.001 to 0.01 inches, optionally about 0.003 inches.

32. The method of any one of claims 29-31, the internal sidewall of the vial extending from the internal portion of the neck, downward to the internal base, the internal sidewall having an inner diameter no greater than the inner diameter of the neck.
